(19) United States
(12) Patent Application Publication
(10) Pub. No.: US 2025/0355612 A1
(43) Pub. Date: Nov. 20, 2025

(54) GROUP SYNCHRONIZATION WITH SHARED CONTENT

(71) Applicant: Apple Inc., Cupertino, CA (US)

(72) Inventors: Remy M. DEMAREST, Santa Clara, CA (US); Adam Y. SYED, San Francisco, CA (US); Conrad A. SHULTZ, San Jose, CA (US)

(21) Appl. No.: 19/285,861

(22) Filed: Jul. 30, 2025

Related U.S. Application Data
(63) Continuation of application No. 18/520,451, filed on Nov. 27, 2023.
(60) Provisional application No. 63/455,241, filed on Mar. 28, 2023.

(51) Int. Cl. G06F 3/14

(52) U.S. Cl. CPC G06F 3/1454

(57) ABSTRACT

Some techniques are described herein for managing personal communications between computer system, managing communication between computer systems with respect to shared content, for updating shared tab group data using a computer system, and for updating shared tab group data using a computer system in accordance with some examples.

### CROSS-REFERENCE TO RELATED APPLICATIONS

This continuation patent application claims priority to U.S. Provisional patent application Ser. No. 18/520,451, entitled “GROUP SYNCHRONIZATION WITH SHARED CONTENT” filed Nov. 27, 2023, and to U.S. Provisional Patent Application Ser. No. 63/455,241, entitled “GROUP SYNCHRONIZATION WITH SHARED CONTENT” filed Mar. 28, 2023, which are hereby incorporated by reference in their entireties for all purposes.

### BACKGROUND

Electronic devices are becoming increasingly interconnected. For example, users often wish to collaborate and share content. Accordingly, there is a need to improve techniques for sharing content.

### SUMMARY

Current techniques for managing communication between computer systems are generally ineffective and/or inefficient. For example, some techniques do not allow users to share portions of content, such as a group of webpages (and/or tabs), a group of slides, and/or a group of sections of a document, with different sets of users. This disclosure provides more effective and/or efficient techniques for managing communication between computer systems while detecting the presence of various users with respect to shared content. It should be recognized that other types of computer systems can be used with techniques described herein. For example, a smartwatch can connect with a laptop using techniques described herein. In addition, techniques optionally complement or replace other techniques for managing communication between computer systems.

Some techniques are described herein for managing communication between computer systems. Summaries of such techniques, in accordance with some examples, are included below.

In some examples, a method that is performed by a computer system is described. In some examples, the method comprises: identifying a browser associated with a user of a computer system; in response to identifying the browser, causing a first connection to be established between the computer system and one or more other computer systems of the user; causing a second connection to be established between the computer system and a service, wherein the second connection is different from the first connection; while the computer system is connected to the one or more other computer systems via the first connection and while the computer system is connected to the service via the second connection, identifying first data concerning the browser; and in response to identifying the first data concerning the browser: in accordance with a determination that the first data includes presence data concerning the browser, sending a message corresponding to the first data via the first connection between the computer system and the one or more other computer systems; and in accordance with a determination that the first data does not include presence data, sending the message corresponding to the first data via the second connection.

In some examples, a non-transitory computer-readable storage medium storing one or more programs configured to be executed by one or more processors of a computer system is described. In some examples, the one or more programs includes instructions for: identifying a browser associated with a user of a computer system; in response to identifying the browser, causing a first connection to be established between the computer system and one or more other computer systems of the user; causing a second connection to be established between the computer system and a service, wherein the second connection is different from the first connection; while the computer system is connected to the one or more other computer systems via the first connection and while the computer system is connected to the service via the second connection, identifying first data concerning the browser; and in response to identifying the first data concerning the browser: in accordance with a determination that the first data includes presence data concerning the browser, sending a message corresponding to the first data via the first connection between the computer system and the one or more other computer systems; and in accordance with a determination that the first data does not include presence data, sending the message corresponding to the first data via the second connection.

In some examples, a transitory computer-readable storage medium storing one or more programs configured to be executed by one or more processors of a computer system is described. In some examples, the one or more programs includes instructions for: identifying a browser associated with a user of a computer system; in response to identifying the browser, causing a first connection to be established between the computer system and one or more other computer systems of the user; causing a second connection to be established between the computer system and a service, wherein the second connection is different from the first connection; while the computer system is connected to the one or more other computer systems via the first connection and while the computer system is connected to the service via the second connection, identifying first data concerning the browser; and in response to identifying the first data concerning the browser: in accordance with a determination that the first data includes presence data concerning the browser, sending a message corresponding to the first data via the first connection between the computer system and the one or more other computer systems; and in accordance with a determination that the first data does not include presence data, sending the message corresponding to the first data via the second connection.

In some examples, a computer system comprising one or more processors and memory storing one or more program configured to be executed by the one or more processors is described. In some examples, the one or more programs includes instructions for: identifying a browser associated with a user of a computer system; in response to identifying the browser, causing a first connection to be established between the computer system and one or more other computer systems of the user; causing a second connection to be established between the computer system and a service, wherein the second connection is different from the first connection; while the computer system is connected to the one or more other computer systems via the first connection and while the computer system is connected to the service via the second connection, identifying first data concerning the browser; and in response to identifying the first data concerning the browser: in accordance with a determination that the first data includes presence data concerning the browser, sending a message corresponding to the first data via the first connection between the computer system and the one or more other computer systems; and in accordance with a determination that the first data does not include presence data, sending the message corresponding to the first data via the second connection.

In some examples, a computer system is comprising means for performing each of the following steps: identifying a browser associated with a user of a computer system; in response to identifying the browser, causing a first connection to be established between the computer system and one or more other computer systems of the user; causing a second connection to be established between the computer system and a service, wherein the second connection is different from the first connection; while the computer system is connected to the one or more other computer systems via the first connection and while the computer system is connected to the service via the second connection, identifying first data concerning the browser; and in response to identifying the first data concerning the browser: in accordance with a determination that the first data includes presence data concerning the browser, sending a message corresponding to the first data via the first connection between the computer system and the one or more other computer systems; and in accordance with a determination that the first data does not include presence data, sending the message corresponding to the first data via the second connection.

In some examples, a computer program product is described. In some examples, the computer program product comprises one or more programs configured to be executed by one or more processors of a computer system. In some examples, the one or more programs include instructions for: identifying a browser associated with a user of a computer system; in response to identifying the browser, causing a first connection to be established between the computer system and one or more other computer systems of the user; causing a second connection to be established between the computer system and a server, wherein the second connection is different from the first connection; while the computer system is connected to the one or more other computer systems via the first connection and while the computer system is connected to the service via the second connection, identifying first data concerning the browser; and in response to identifying the first data concerning the browser: in accordance with a determination that the first data includes presence data concerning the browser, sending a message corresponding to the first data via the first connection between the computer system and the one or more other computer systems; and in accordance with a determination that the first data does not include presence data, sending the message corresponding to the first data via the second connection.

In some examples, a method that is performed by a computer system is described. In some examples, the method comprises: causing a first connection to be established between the first computer system of the first user and a second computer system of the first user; identifying a first portion of a subset of content; and after causing the first connection be established and identifying the first portion of the subset of content: in accordance with a determination that the presence of a first user using a first computer system of the first user is detected with respect to the subset and that the subset is designed as being shared, causing a second connection to be established between the first computer system of the first user and a third computer system of a second user different from the first user while maintaining the first connection; and in accordance with a determination that the presence of the first computer system of the first user is detected with respect to the subset and that the subset is not designed as being shared, maintaining the first connection without causing the second connection to be established between the first computer system of the first user and the third computer system of the second user.

In some examples, a non-transitory computer-readable storage medium storing one or more programs configured to be executed by one or more processors of a computer system is described. In some examples, the one or more programs includes instructions for: causing a first connection to be established between the first computer system of the first user and a second computer system of the first user; identifying a first portion of a subset of content; and after causing the first connection be established and identifying the first portion of the subset of content: in accordance with a determination that the presence of a first user using a first computer system of the first user is detected with respect to the subset and that the subset is designed as being shared, causing a second connection to be established between the first computer system of the first user and a third computer system of a second user different from the first user while maintaining the first connection; and in accordance with a determination that the presence of the first computer system of the first user is detected with respect to the subset and that the subset is not designed as being shared, maintaining the first connection without causing the second connection to be established between the first computer system of the first user and the third computer system of the second user.

In some examples, a transitory computer-readable storage medium storing one or more programs configured to be executed by one or more processors of a computer system is described. In some examples, the one or more programs includes instructions for: causing a first connection to be established between the first computer system of the first user and a second computer system of the first user; identifying a first portion of a subset of content; and after causing the first connection be established and identifying the first portion of the subset of content: in accordance with a determination that the presence of a first user using a first computer system of the first user is detected with respect to the subset and that the subset is designed as being shared, causing a second connection to be established between the first computer system of the first user and a third computer system of a second user different from the first user while maintaining the first connection; and in accordance with a determination that the presence of the first computer system of the first user is detected with respect to the subset and that the subset is not designed as being shared, maintaining the first connection without causing the second connection to be established between the first computer system of the first user and the third computer system of the second user.

In some examples, a computer system comprising one or more processors and memory storing one or more program configured to be executed by the one or more processors is described. In some examples, the one or more programs includes instructions for: causing a first connection to be established between the first computer system of the first user and a second computer system of the first user; identifying a first portion of a subset of content; and after causing the first connection be established and identifying the first portion of the subset of content: in accordance with a determination that the presence of a first user using a first computer system of the first user is detected with respect to the subset and that the subset is designed as being shared, causing a second connection to be established between the first computer system of the first user and a third computer system of a second user different from the first user while maintaining the first connection; and in accordance with a determination that the presence of the first computer system of the first user is detected with respect to the subset and that the subset is not designed as being shared, maintaining the first connection without causing the second connection to be established between the first computer system of the first user and the third computer system of the second user.

In some examples, a computer system is comprising means for performing each of the following steps: causing a first connection to be established between the first computer system of the first user and a second computer system of the first user; identifying a first portion of a subset of content; and after causing the first connection be established and identifying the first portion of the subset of content: in accordance with a determination that the presence of a first user using a first computer system of the first user is detected with respect to the subset and that the subset is designed as being shared, causing a second connection to be established between the first computer system of the first user and a third computer system of a second user different from the first user while maintaining the first connection; and in accordance with a determination that the presence of the first computer system of the first user is detected with respect to the subset and that the subset is not designed as being shared, maintaining the first connection without causing the second connection to be established between the first computer system of the first user and the third computer system of the second user.

In some examples, a computer program product is described. In some examples, the computer program product comprises one or more programs configured to be executed by one or more processors of a computer system. In some examples, the one or more programs include instructions for: causing a first connection to be established between the first computer system of the first user and a second computer system of the first user; identifying a first portion of a subset of content; and after causing the first connection be established and identifying the first portion of the subset of content: in accordance with a determination that the presence of a first user using a first computer system of the first user is detected with respect to the subset and that the subset is designed as being shared, causing a second connection to be established between the first computer system of the first user and a third computer system of a second user different from the first user while maintaining the first connection; and in accordance with a determination that the presence of the first computer system of the first user is detected with respect to the subset and that the subset is not designed as being shared, maintaining the first connection without causing the second connection to be established between the first computer system of the first user and the third computer system of the second user.

In some examples, a method that is performed by a first computer system that is in communication with a display generation component and that is associated with a first user is described. In some examples, the method comprises: displaying, via the display generation component, a first indication that a presence of a second user is detected in relation to a first portion of a subset of content, wherein the subset of content is shared between the first user and a second user, wherein the first computer system is connected to a second computer system of the second user and not connected to a third computer system of the second user, and wherein the second user is different from the first user; while displaying the first indication, receiving a message; and in conjunction with receiving the message: in accordance with the second computer system being active with respect to a second portion of the subset of content different from the first portion of the subset of content, displaying, via the display generation component, a second indication that a presence of the second user is detected in relation to the second portion of the subset of content without displaying the first indication; and in accordance with the third computer system being active with respect to the second portion of the subset of content, displaying, via the display generation component, the second indication without displaying the first indication.

In some examples, a non-transitory computer-readable storage medium storing one or more programs configured to be executed by one or more processors of a first computer system that is in communication with a display generation component and that is associated with a first user is described. In some examples, the one or more programs includes instructions for: displaying, via the display generation component, a first indication that a presence of a second user is detected in relation to a first portion of a subset of content, wherein the subset of content is shared between the first user and a second user, wherein the first computer system is connected to a second computer system of the second user and not connected to a third computer system of the second user, and wherein the second user is different from the first user; while displaying the first indication, receiving a message; and in conjunction with receiving the message: in accordance with the second computer system being active with respect to a second portion of the subset of content different from the first portion of the subset of content, displaying, via the display generation component, a second indication that a presence of the second user is detected in relation to the second portion of the subset of content without displaying the first indication; and in accordance with the third computer system being active with respect to the second portion of the subset of content, displaying, via the display generation component, the second indication without displaying the first indication.

In some examples, a transitory computer-readable storage medium storing one or more programs configured to be executed by one or more processors of a first computer system that is in communication with a display generation component and that is associated with a first user is described. In some examples, the one or more programs includes instructions for: displaying, via the display generation component, a first indication that a presence of a second user is detected in relation to a first portion of a subset of content, wherein the subset of content is shared between the first user and a second user, wherein the first computer system is connected to a second computer system of the second user and not connected to a third computer system of the second user, and wherein the second user is different from the first user; while displaying the first indication, receiving a message; and in conjunction with receiving the message: in accordance with the second computer system being active with respect to a second portion of the subset of content different from the first portion of the subset of content, displaying, via the display generation component, a second indication that a presence of the second user is detected in relation to the second portion of the subset of content without displaying the first indication; and in accordance with the third computer system being active with respect to the second portion of the subset of content, displaying, via the display generation component, the second indication without displaying the first indication.

In some examples, a first computer system that is in communication with a display generation component and that is associated with a first user is described. In some examples, the first computer system that is in communication with a display generation component and that is associated with a first user comprises one or more processors and memory storing one or more program configured to be executed by the one or more processors. In some examples, the one or more programs includes instructions for: displaying, via the display generation component, a first indication that a presence of a second user is detected in relation to a first portion of a subset of content, wherein the subset of content is shared between the first user and a second user, wherein the first computer system is connected to a second computer system of the second user and not connected to a third computer system of the second user, and wherein the second user is different from the first user; while displaying the first indication, receiving a message; and in conjunction with receiving the message: in accordance with the second computer system being active with respect to a second portion of the subset of content different from the first portion of the subset of content, displaying, via the display generation component, a second indication that a presence of the second user is detected in relation to the second portion of the subset of content without displaying the first indication; and in accordance with the third computer system being active with respect to the second portion of the subset of content, displaying, via the display generation component, the second indication without displaying the first indication.

In some examples, a first computer system that is in communication with a display generation component and that is associated with a first user is described. In some examples, the first computer system that is in communication with a display generation component and that is associated with a first user comprises means for performing each of the following steps: displaying, via the display generation component, a first indication that a presence of a second user is detected in relation to a first portion of a subset of content, wherein the subset of content is shared between the first user and a second user, wherein the first computer system is connected to a second computer system of the second user and not connected to a third computer system of the second user, and wherein the second user is different from the first user; while displaying the first indication, receiving a message; and in conjunction with receiving the message: in accordance with the second computer system being active with respect to a second portion of the subset of content different from the first portion of the subset of content, displaying, via the display generation component, a second indication that a presence of the second user is detected in relation to the second portion of the subset of content without displaying the first indication; and in accordance with the third computer system being active with respect to the second portion of the subset of content, displaying, via the display generation component, the second indication without displaying the first indication.

In some examples, a computer program product is described. In some examples, the computer program product comprises one or more programs configured to be executed by one or more processors of a first computer system that is in communication with a display generation component and that is associated with a first user. In some examples, the one or more programs include instructions for: displaying, via the display generation component, a first indication that a presence of a second user is detected in relation to a first portion of a subset of content, wherein the subset of content is shared between the first user and a second user, wherein the first computer system is connected to a second computer system of the second user and not connected to a third computer system of the second user, and wherein the second user is different from the first user; while displaying the first indication, receiving a message; and in conjunction with receiving the message: in accordance with the second computer system being active with respect to a second portion of the subset of content different from the first portion of the subset of content, displaying, via the display generation component, a second indication that a presence of the second user is detected in relation to the second portion of the subset of content without displaying the first indication; and in accordance with the third computer system being active with respect to the second portion of the subset of content, displaying, via the display generation component, the second indication without displaying the first indication.

In some examples, a method that is performed by a computer system is described. In some examples, the method comprises: while indicating that a scroll position of a first user is at a first scroll position on a user interface, receiving a first message that a first computer system of the first user has scrolled to a second position on the user interface; in response to receiving the first message, indicating that the scroll position of the first user is at the second scroll position different from the first scroll position; after indicating that the scroll position of the first user is at the second scroll position and before indicating that the scroll position of the first user is at a first different scroll position, receiving a second message that a second computer system of the first user has scrolled to a third position on the user interface, wherein the second computer system is different from the first computer system; and in response to receiving the second message, indicating that the scroll position of the first user is at the third scroll position different from the second scroll position without indicating that the scroll position of the first user is at the second scroll position.

In some examples, a non-transitory computer-readable storage medium storing one or more programs configured to be executed by one or more processors of a computer system is described. In some examples, the one or more programs includes instructions for: while indicating that a scroll position of a first user is at a first scroll position on a user interface, receiving a first message that a first computer system of the first user has scrolled to a second position on the user interface; in response to receiving the first message, indicating that the scroll position of the first user is at the second scroll position different from the first scroll position; after indicating that the scroll position of the first user is at the second scroll position and before indicating that the scroll position of the first user is at a first different scroll position, receiving a second message that a second computer system of the first user has scrolled to a third position on the user interface, wherein the second computer system is different from the first computer system; and in response to receiving the second message, indicating that the scroll position of the first user is at the third scroll position different from the second scroll position without indicating that the scroll position of the first user is at the second scroll position.

In some examples, a transitory computer-readable storage medium storing one or more programs configured to be executed by one or more processors of a computer system is described. In some examples, the one or more programs includes instructions for: while indicating that a scroll position of a first user is at a first scroll position on a user interface, receiving a first message that a first computer system of the first user has scrolled to a second position on the user interface; in response to receiving the first message, indicating that the scroll position of the first user is at the second scroll position different from the first scroll position; after indicating that the scroll position of the first user is at the second scroll position and before indicating that the scroll position of the first user is at a first different scroll position, receiving a second message that a second computer system of the first user has scrolled to a third position on the user interface, wherein the second computer system is different from the first computer system; and in response to receiving the second message, indicating that the scroll position of the first user is at the third scroll position different from the second scroll position without indicating that the scroll position of the first user is at the second scroll position.

In some examples, a computer system comprising one or more processors and memory storing one or more program configured to be executed by the one or more processors is described. In some examples, the one or more programs includes instructions for: while indicating that a scroll position of a first user is at a first scroll position on a user interface, receiving a first message that a first computer system of the first user has scrolled to a second position on the user interface; in response to receiving the first message, indicating that the scroll position of the first user is at the second scroll position different from the first scroll position; after indicating that the scroll position of the first user is at the second scroll position and before indicating that the scroll position of the first user is at a first different scroll position, receiving a second message that a second computer system of the first user has scrolled to a third position on the user interface, wherein the second computer system is different from the first computer system; and in response to receiving the second message, indicating that the scroll position of the first user is at the third scroll position different from the second scroll position without indicating that the scroll position of the first user is at the second scroll position.

In some examples, a computer system is comprising means for performing each of the following steps: while indicating that a scroll position of a first user is at a first scroll position on a user interface, receiving a first message that a first computer system of the first user has scrolled to a second position on the user interface; in response to receiving the first message, indicating that the scroll position of the first user is at the second scroll position different from the first scroll position; after indicating that the scroll position of the first user is at the second scroll position and before indicating that the scroll position of the first user is at a first different scroll position, receiving a second message that a second computer system of the first user has scrolled to a third position on the user interface, wherein the second computer system is different from the first computer system; and in response to receiving the second message, indicating that the scroll position of the first user is at the third scroll position different from the second scroll position without indicating that the scroll position of the first user is at the second scroll position.

In some examples, a computer program product is described. In some examples, the computer program product comprises one or more programs configured to be executed by one or more processors of a computer system. In some examples, the one or more programs include instructions for: while indicating that a scroll position of a first user is at a first scroll position on a user interface, receiving a first message that a first computer system of the first user has scrolled to a second position on the user interface; in response to receiving the first message, indicating that the scroll position of the first user is at the second scroll position different from the first scroll position; after indicating that the scroll position of the first user is at the second scroll position and before indicating that the scroll position of the first user is at a first different scroll position, receiving a second message that a second computer system of the first user has scrolled to a third position on the user interface, wherein the second computer system is different from the first computer system; and in response to receiving the second message, indicating that the scroll position of the first user is at the third scroll position different from the second scroll position without indicating that the scroll position of the first user is at the second scroll position.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1 is a block diagram illustrating a compute system.

FIG. 2 is a block diagram illustrating a device with interconnected subsystems.

FIG. 3 is a block diagram illustrating a network in accordance with some examples.

FIGS. 4A-4B illustrate exemplary user interfaces for displaying shared content groups in accordance with some examples.

FIGS. 5A-5B are an exemplary lane diagram for managing communication between computer systems in accordance with some examples.

FIG. 6 is an exemplary block diagram representing connections between computer systems in accordance with some examples.

FIGS. 7A-7C are an exemplary lane diagram for managing communication between computer systems in accordance with some examples.

FIG. 8 is an exemplary block diagram representing connections between computer systems in accordance with some examples.

FIG. 9 is a flow diagram illustrating a method for managing personal communications between computer systems of a user in accordance with some examples.

FIG. 10 is a flow diagram illustrating a method for managing communication between computer systems with respect to shared content in accordance with some examples.

FIG. 11 is a flow diagram illustrating a method for managing messages with respect to shared content in accordance with some examples.

FIGS. 12A and 12B illustrate exemplary user interfaces for updating shared tab group data in accordance with some examples.

FIG. 13 is a flow diagram illustrating a method for updating shared tab group data in accordance with some examples.

### DETAILED DESCRIPTION

The following description sets forth exemplary methods, parameters, and the like. It should be recognized, however, that such description is not intended as a limitation on the scope of the present disclosure but is instead provided as a description of examples.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described examples. In some examples, the first subsystem and the second subsystem are two separate references to the same subsystem. In some examples, the first subsystem and the second subsystem are both subsystem, but they are not the same subsystem or the same type of subsystem.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

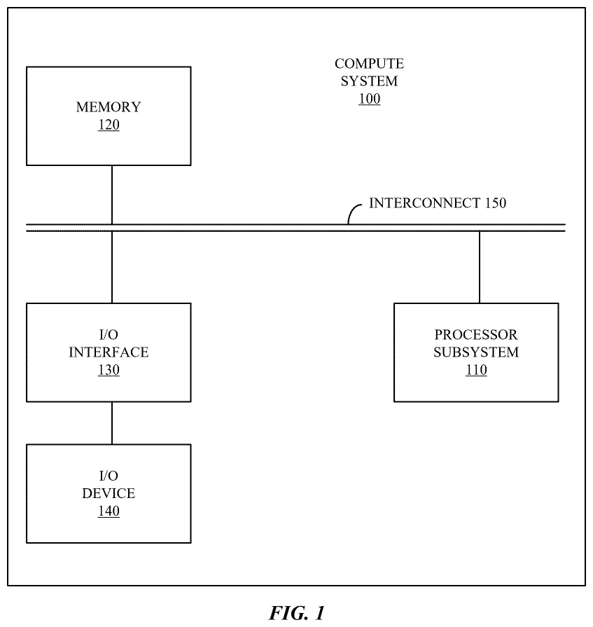

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 900, 1000, 1100, and 1300 described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

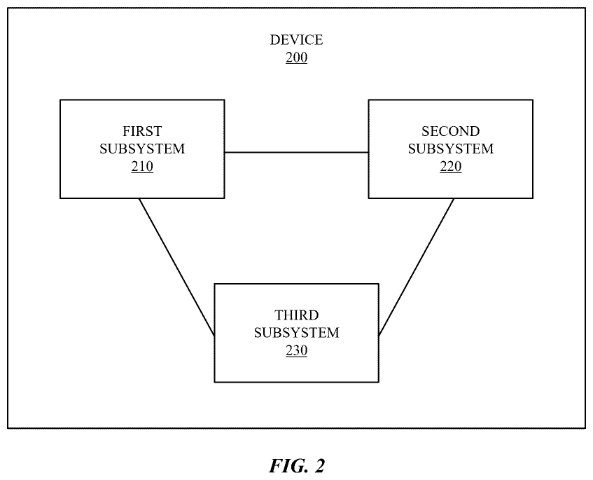

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

As used herein, an “installed application” refers to a software application that has been downloaded onto a computer system (e.g., compute system 100 and/or device 200) and is ready to be launched (e.g., become opened) on the device. In some examples, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of a system/global internal state and/or an application internal state). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards techniques for managing communication between computer systems. Such techniques are described in the context of detecting the presence of a user with respect to tabs and/or shared tab groups. It should be recognized that similar techniques to those described herein can apply to a variety of situations other than shared tab groups, such as shared slides in a slide presentation, shared workbooks in a spreadsheet, shared sections in a document, and/or shared content in a media library. In addition, techniques optionally complement or replace other techniques for managing communication between computer systems with respect to detecting the presence of a user with respect to shared tab groups.

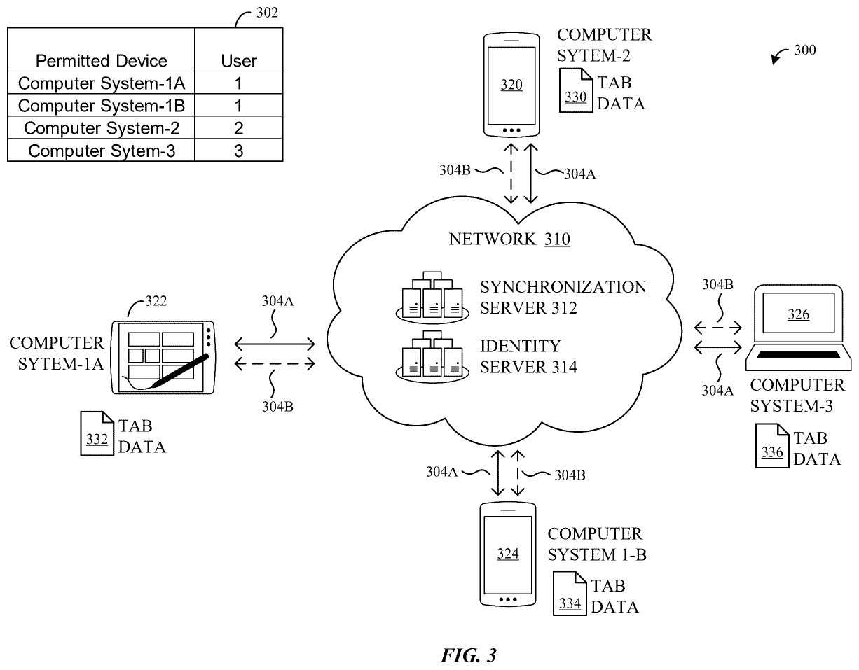

FIG. 3 illustrate a network in accordance with some examples. In particular, FIG. 3 is an example network diagram 300 of computer systems that are configured to synchronize a copy of tab data (e.g., tab data 330, 332, 334, and/or 336). FIG. 3 illustrates a set of computer systems that are associated with (e.g., belonging to, identified by, and/or registered with) one of users 1, 2, and 3. As indicated in table 302, computer system-2 320 is associated with user 2, computer system-1A 322 and computer system-1B 324 are both associated with user 1, and computer system-3 326 is associated with user 3, wherein each of users 1, 2, and 3 are different from each other. In this example, computer system-2 320 and computer system-1B 324 are each a smartphone, computer system-1A 322 is a tablet computer, and computer system-3 326 is a laptop computer. It should be recognized that other types of computer systems can be used, other combinations of types of computer systems, more or fewer computer systems for a user, and/or more or fewer users and/or user accounts can be used with the techniques described herein.

In some examples, each user is associated with a unique identity and/or user account. In some of these examples, computer system-2 320 is registered with a user account for user 2, computer system-1A 322 and computer system-1B 324 are registered with a user account for user 1 (e.g., the same user account), and computer system-3 326 is registered with a user account for user 3. In some examples, computer system-1A 322 and computer system-1B 324 are registered with the same user account. In some examples, a computer system being registered with a user account includes the computer system being logged into the user account. In some examples, a computer system operates according to one or more settings of the user account when the computer system is logged into the user account. In some examples, one or more of the computer systems and/or servers depicted in FIG. 3 (synchronization server 312, identity server 314, computer system-2 320, computer system-1A 322, computer system-1B 324, and/or computer system-3 326) include one or more features of compute system 100 of FIG. 1 and/or device 200 of FIG. 2.

At FIG. 3, the four computer systems (computer system-2 320, computer system-1A 322, computer system-1B 324, and computer system-3 326) are part of a group activity session. In particular, the group activity session involves a shared tab group. In some examples, a shared tab group is a collection of web browser tabs (e.g., each corresponding to a web page) (e.g., or other content) that is shared between a set of users (e.g., two or more users). In some examples, each user of the set of users that is sharing the collection of web browser tabs (e.g., that is a member of the group activity session) can perform one or more of the following: view tabs in the collection, edit tabs in the collection (e.g., add, remove, and/or delete), rearrange tabs in the collection, and/or view other user activity with respect to the collection (e.g., which tab is being viewed by a user, and/or a scroll location and/or cursor location of a user on a webpage associated a tab in the collection). In some examples, the group activity involves sharing other application components besides tabs and/or webpages, such as sharing sections of a document (e.g., where some sections of the document are hidden from one set of users and are available to another set of users), slides of a presentation (e.g., where some slides of a presentation are hidden from one set of users and are available to another set of users), and/or workbooks of a spreadsheet (e.g., where some workbooks of the spreadsheet are hidden from one set of users and are available to another set of users).

At FIG. 3, each computer system (computer system-2 320, computer system-1A 322, computer system-1B 324, and computer system-3 326) is associated with a copy of tab data (and/or webpage data) that includes at least tab data for user activity occurring on that respective computer system. The tab data can also include shared tab group data (e.g., activity of other computer systems and/or users in the shared tab group). In some examples, the tab data is stored locally in memory of the respective computer system. For example, computer system-2 320 stores tab data 330, computer system-1A 322 stores tab data 332, computer system-1B 324 stores tab data 334, and computer system-3 326 stores tab data 336.

Network diagram 300 includes network 310, which represents one or more interconnected networks used for communication between computer systems (e.g., the Internet, a wide area network (WAN), a local area network (LAN), and/or some combination of these). Synchronization server 312 and identity server 314 are depicted within network 310 to merely illustrate that they can be accessed via (e.g., by communication over, though, and/or including) the network 310, and should not be interpreted as necessarily being part of network components and/or hosted by a network provider. The computer systems illustrated in FIG. 3 can use network 310 to synchronize tab data for a shared tab group.

In some examples, synchronization server 312 performs one or more functions related to a group activity session for collaborating with respect to tab data. In some examples, synchronization server 312 manages a presence of a user and/or computer system within a group activity session. For example, synchronization server 312 can receive communication from a computer system that serves to establish whether a user and/or computer system is present in the group activity session and/or a level of presence (e.g., amount of activity). In some examples, presence is established based on an indication of an activity state (e.g., representing an amount of activity) of a user and/or computer system. In some examples, presence is based on one or more of: at least a threshold amount of activity and/or whether certain types of activity are performed (e.g., open on a computer system screen, rather than minimized). For example, synchronization server 312 can receive an indication that computer system-2 320 is present in the shared tab group (e.g., actively browsing a tab in the shared tab group). In conjunction with (e.g., before, together with, and/or after) transmitting an indication that the computer system-2 320 is present in the activity session (e.g., has the file open and is engaging in a threshold amount or type of activity), the computer system-2 320 establishes a connection with synchronization server 312 for synchronizing with the other members of the group activity (e.g., computer system-1B 324) that are present. In some examples, the second data channel is established in response to an indication that the computer system-2 320 has accessed the data object (e.g., opened the file).

A communication from a computer system that serves to establish presence can include an identifier (e.g., unique identifier) of tab data (e.g., a shared tab and/or a shared tab group), an indication of an activity state of the computer system with respect to tab data, a user account associated with the computer system, and/or a request to subscribe to updates to tab data from other computer systems and/or user accounts that are members of the group activity session. For example, a group activity session created for a specific group activity (e.g., for a shared tab group) can be identified by a respective unique identifier (e.g., such that two different shared tab groups each have a different unique identifier). In some examples, a computer system (e.g., computer system-2 320) can send a notification communication to synchronization server 312 that causes one or more of the following to occur: (1) synchronization server 312 causes other computer systems that are also present in the group activity session to be notified of the presence of the newly joined computer system, and/or (2) synchronization server 312 causes the newly joined computer system to be subscribed to notifications related to the group activity session. Regarding (1), this can provide other computer systems notice that a new computer system has joined and/or performed a certain type or level of activity with respect to tab data, which can be used to make decisions regarding synchronization (e.g., when to synchronize updated tab data). Regarding (2), this can allow the newly joined computer system to stay updated about which users and/or computer systems are present in the group activity session and/or receive synchronization updates from the other computer systems.

In some examples, whether a computer system and/or user (e.g., user account) is joined to a group activity session depends on the presence of the computer system and/or user. For example, by using the concept of presence, merely opening an application (e.g., web browser) might not be enough to cause a real-time data channel to be established (e.g., which wastes resources if the user then immediately closes the application). A selective process for synchronization based on presence can allow a computer system to know when to, for example, upgrade a connection or bandwidth for real-time synchronization. In some examples, presence is a sliding scale. For example, higher activity can lead to a higher level (e.g., some quantified amount) of presence-which in turn can be used to increase the synchronization rate higher than for lower levels of presence. In some examples, presence is binary (e.g., the user is present or not present).

At FIG. 3, identity server 314 represents one or more servers that manages access to account information and/or personal storage (e.g., per user storage) for one or more users. For example, identity server 314 is a cloud service provider server that stores tab data for each computer system (computer system-2 320, computer system-1A 322, computer system-1B 324, and/or computer system-3 326) and/or user (e.g., user 1, user 2, and/or user 3). In some examples, identity server 314 shares tab data for each computer system between other computer systems associated with the same user. For example, because the computer systems are both associated with user 1, identity server 314 shares tab data 332 of computer system-1A 322 with computer system-1B 324, and shares tab data 334 of computer system-1B 324 with computer system-1A 322; in contrast, because computer system-2 320 or computer system-3 326 are not associated with user 1, identity server 314 does not share tab data 332 or 334 with computer system-2 320 or computer system-3 326. In some examples, identity server 314 stores and/or shares other data, such as account information, photos, media, and/or preference data associated with a user account. In some examples, identity server 314 shares and/or collects data from multiple applications, such as a browser application, a spreadsheet application, a media application, and/or a word-processing application.

In some examples, one or more computer systems communicate with each other and/or one or more servers via network 310. In some examples, such communications occur via one or more connections. In some examples, a computer system connects to identity server 314 using a first connection and connects to synchronization server 312 using a second connection different from the first connection. For example, as illustrated in FIG. 3, each computer system (computer system-2 320, computer system-1A 322, computer system-1B 324, and computer system-3 326) connects to identity server 314 using connection 304A and connects to synchronization server 312 using connection 304B.

As illustrated in FIG. 3, each computer system (computer system-2 320, computer system-1A 322, computer system-1B 324, and computer system-3 326) can each include a copy of their own respective tab data (tab data 330, tab data 332, tab data 334, or tab data 336) locally stored to memory before being synchronized with other computer systems. In some examples, synchronization of tab data occurs (1) between each computer system and the other computer systems, (2) between each computer system and other computer systems associated with other user accounts, and/or (3) between each computer system and other computer systems associated with the same user account. For example, there can be many ways that synchronization data is exchanged and/or routed. Several are described herein, but the scenarios described herein are not intended to be necessarily exhaustive. As shown in network diagram 300, each computer system (computer system-2 320, computer system-1A 322, computer system-1B 324, and computer system-3 326) communicates via network 310 (e.g., through connection 304A and/or connection 304B). This communication can occur with at least one of synchronization server 312 and/or identity server 314. In some examples, synchronization server 312 handles (e.g., relays, receives, routes, and/or retransmits) synchronization of tab data that is exchanged between computer systems. For example, synchronization server 312 can act as an intermediary for updates between computer systems associated with different users (e.g., between computer system-2 320 associated with user 2 and computer system-1A 322 associated with user 1). In some examples, identity server 314 handles (e.g., relays, receives, routes, and/or retransmits) synchronization between computer systems associated with the same user (e.g., between computer system-1A 322 associated with user 1 and computer system-1A 324 associated with user 1).

Regardless of whether communication happens through synchronization server 312 and/or identity server 314 as an intermediary, network diagram 300 depicts bidirectional communication between each computer system joined to a group activity session for performing synchronization during the group activity session. In some examples, connection 304A is a data channel that is separate from what is used to synchronize with identity server 314 (e.g., connection 304B). As an example, a first data channel (e.g., connection 304A) can be used to synchronize with synchronization server 312 for synchronization of updates between members of a group activity session, and a second data channel (e.g., connection 304B) can be established and used to synchronize with identity server 314. In some examples, a computer system configures a respective first data channel by causing setup of a plugin instance that transmits messages to synchronization server 312. In some examples, synchronization server 312 multicasts messages received, from the computer system via the first data channel, to other members of a group activity (e.g., computer systems subscribed to updates for the group activity session). A “pub/sub” model (publish and subscribe model) can be used to relay messages (e.g., updates, notifications, indications, etc.) between members of the group activity session. In a pub-sub model, a computer system and/or user sets up a connection to a server and becomes a subscriber to anyone sending updates, and when updates are published all subscribers will receive them. In some examples, synchronization server 312 comprises one or more notification servers. For example, synchronization server 312 accepts published messages and sends to subscribers without necessarily knowing the number of computer systems and/or users present in the group activity session, the identity of such users and/or computer systems, and/or the content of the group activity session (e.g., websites represented in the shared tab group). In some examples, the respective computer systems and/or users that are members of the group activity session are provided information regarding the number of computer systems and/or users, identities, and/or content.

It should be noted that while reference is made to synchronization server 312, there can be more than one synchronization server. Further, synchronization server 312 can refer to a plurality of servers that each perform a different function with respect to collaboration and/or synchronization. For example, there can be one server that determines presence and manages subscriptions to the group activity session, a separate server that handles pushing presence notifications and/or updates to members of a group activity, a separate server for data transfer over a data channel used for synchronization, a separate server for managing harmonization of updates to tab data, or the like. The use of the collective phrase “synchronization server” is merely used to represent one or more servers that provide support and/or perform operations for enabling the processes described herein, in accordance with some examples.

It should be noted that while reference is made to identity server 314, there can be more than one identity server. Further, identity server 314 can refer to a plurality of servers that each perform a different function with respect to collaboration and/or identity. The use of the collective phrase “identity server” is merely used to represent one or more servers that provide support and/or perform operations for enabling the processes described herein, in accordance with some examples.

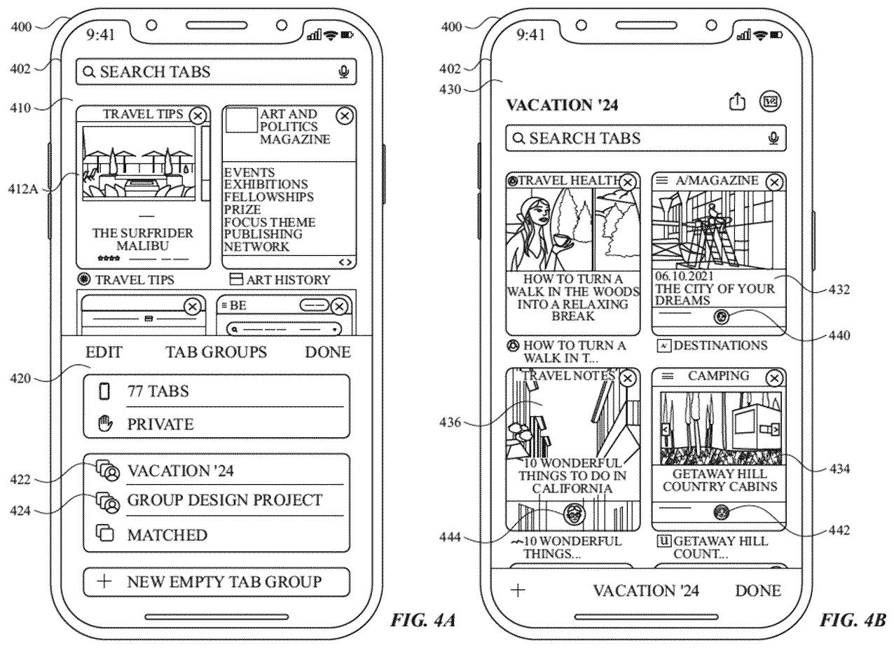

FIGS. 4A-4B illustrate exemplary user interfaces for displaying shared content groups in accordance with some examples. In particular, FIG. 4A illustrates computer system 400 that includes a display component: touch-sensitive display 402 (herein after “display 402”). In some examples, computer system 400 includes one or more features of compute system 100 of FIG. 1 and/or device 200 of FIG. 2.

As illustrated in FIG. 4A, computer system 400 displays, via display 402, a tab management interface 410 of a web browser application installed on computer system 400. In a first region, tab management interface 410 includes tab 412A, which represents a web page that is part of a currently selected tab group (e.g., the tab group named “77 Tabs”). As illustrated in FIG. 4A, computer system 400 displays (in a second region) tab group selection interface 420, for selecting between tab groups that computer system 400 can access. Tab group selection interface 420 includes controls to change between tab groups, including shared tab group 422 (labeled “Vacation '24”) and shared tab group 424 (labeled “Group Design Project”). Shared tab group 422 and shared tab group 424 each correspond to a different shared tab group. For example, shared tab group 422 includes a first set of members (e.g., users, user accounts, and/or computer systems) and a first set of tabs, and shared tab group 424 includes a second set of members (optionally different from the first set of members) and a second set of tabs (optionally different from the second set of tabs). At FIG. 4A, shared tab group 422 and shared tab group 424 are both visible because a user, associated with (e.g., logged into and/or authorized to use) computer system 400 and/or the browser application, is a member of both the first set of members and the second set of members. In some examples, a member identifies a computer system and/or user. As illustrated in FIG. 4A, shared tab group 422 and shared tab group 424 each include an indicator identifying them as a shared tab group. For example, the indicator is the round icon in 422 and 424 with an outline of a person's head (in contrast to the tab group below 424 labeled “Matched,” which does not include an indicator that is a round icon with an outline of a person's head). In some examples, a shared tab group can include one or more tabs.

FIG. 4B illustrates a user interface displayed by computer system 400 in response to detecting selection of (e.g., a tap input on) shared tab group 422 in FIG. 4A. As illustrated in FIG. 4B, in response to the selection, computer system 400 displays, via display 402, tab management interface 430 of a web browser application installed on computer system 400. In a header region, tab management interface 430 includes a name of the shared tab group (“Vacation '24”). In a first region, tab management interface 430 includes tab 432, tab 434, and tab 436, each representing a web page that is included in the currently selected tab group (e.g., the tab group named “Vacation '24”). As illustrated in FIG. 4B, tab management interface 430 includes first user indicator 440 (associated with a first user), second user indicator 442 (associated with a second user different from the first user), and third user indicator 444 (associated with a third user different from the first and second user). Each of these user indicators represents another user that is a member of the shared tab group and that is currently present within the shared tab group (e.g., browsing a tab, and/or interacting with a tab). Each of the user indicators illustrated in FIG. 4B are positioned (e.g., overlaid) on a respective tab, which represents the tab in which the respective user is currently present (e.g., browsing and/or interacting with): first user indicator 440 indicates the first user is present in tab 432, second user indicator 442 indicates the second user is present in tab 434, and third user indicator 444 indicates the third user is present in tab 436.

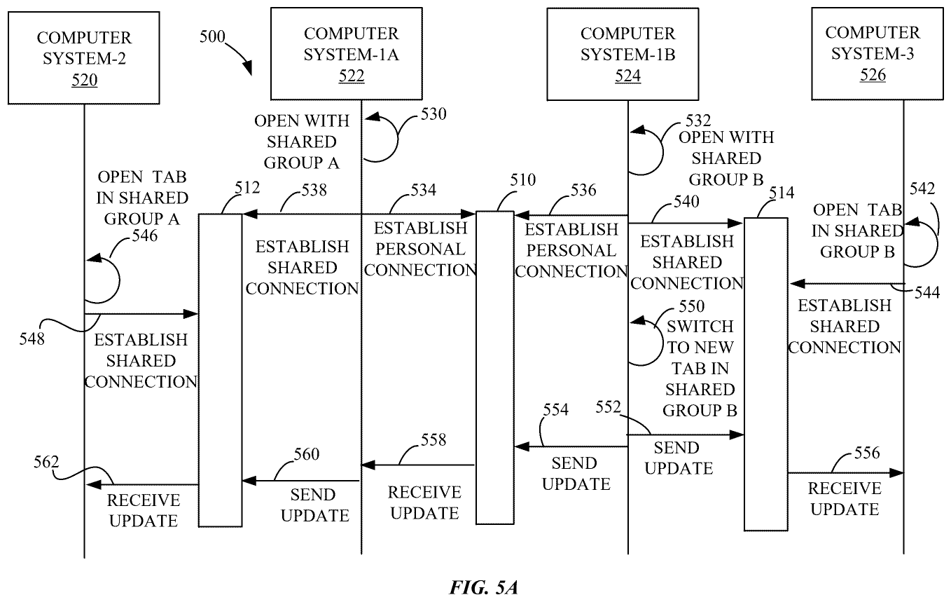

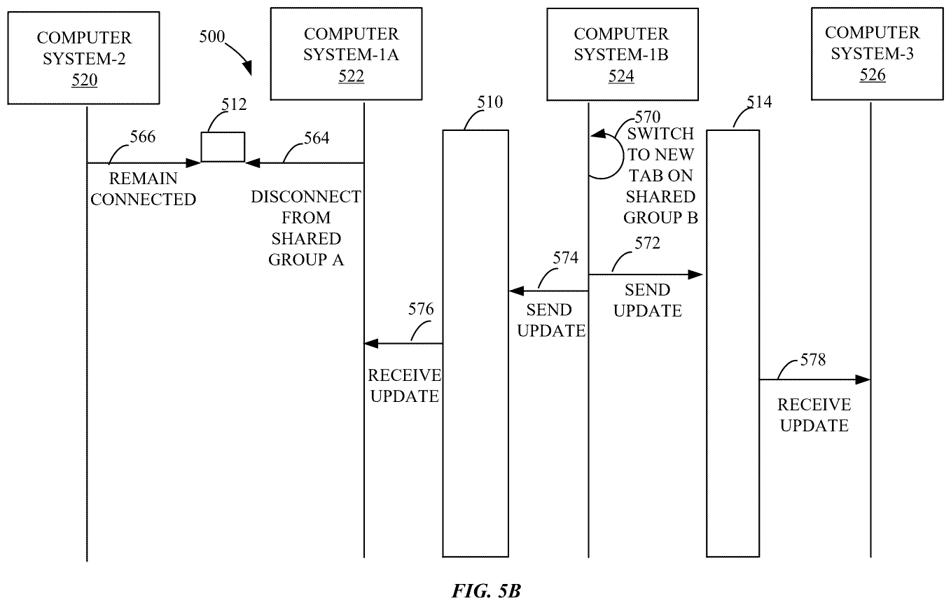

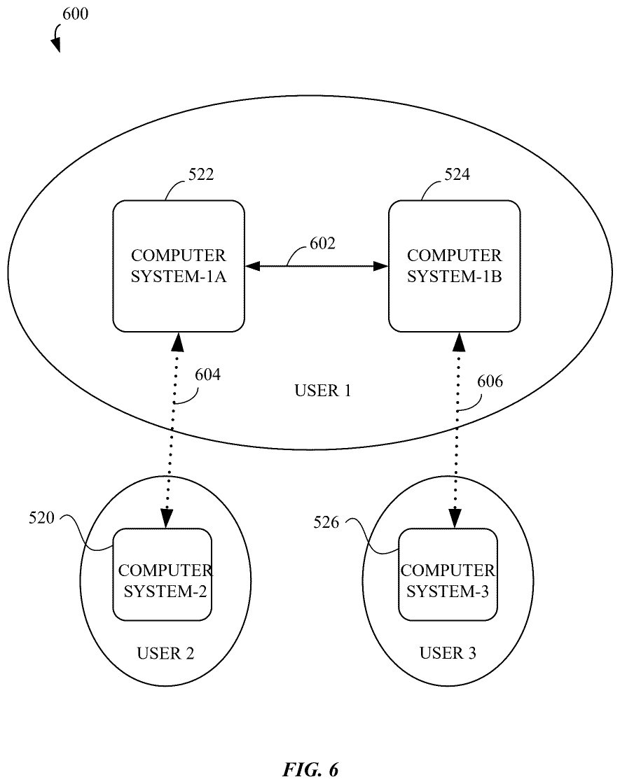

FIGS. 5A-5B are exemplary lane diagram 500 for managing communication between computer systems in accordance with some examples, and FIG. 6 is exemplary block diagram 600 representing connections between computer systems in accordance with some examples. In particular, FIG. 6 is provided to show the connections between computer system-2 520, computer system-1A 522, computer system-1B 524, and computer system-3 526 that are made while one or more steps of FIGS. 5A-5B occur. Computer system-2 520 is a computer system that is associated with user 2 discussed above in relation to FIG. 3 and includes one or more characteristics of computer system 320 of FIG. 3. Computer system-1A 522 and computer system-1B 524 are computer systems that are associated with user 1 discussed above in relation to FIG. 3 and include one or more characteristics of computer system 322 and computer system 324 of FIG. 3, respectively. Computer system-3 526 is a computer system that is associated with user 3 discussed above in relation to FIG. 3 and includes one or more characteristics of computer system 326 of FIG. 3. In some examples, one or more of computer systems 522-526 include one or more characteristics of compute system 100 of FIG. 1 and/or device 200 of FIG. 2.

Turning to FIG. 5A, at 530, computer system-1A 522 opens a tab in shared tab group A by opening a browser application and/or causing the browser application (e.g., such an application including the interfaces 410 and/or 430 described above in relation to FIGS. 4A-4B) to execute in the foreground. Shared tab group A is a subset (e.g., a group and/or collection) of shared tabs. In addition, at 532, computer system-1B 524 opens a tab in shared tab group B by opening a browser application and/or causing the browser application to operate in the foreground. Shared tab group B is a subset of shared tabs. Shared tab group A is a different group of shared tabs than shared tab group B. In some examples, shared tab group A is shared tab group 422 and shared tab group B is shared tab group 424 of FIG. 4A, or vice-versa. In some examples, shared tab group A and/or shared tab group B include one or more characteristics of one or more shared tab groups discussed above in relation to FIGS. 4A-4B.

At 534-536, computer system-1A 522 establishes a personal connection with computer system-1B 524 (e.g., via, in some examples, personal connection activity 510 (e.g., using one or more techniques described above in relation to activity sessions of FIG. 3)) upon computer system-1A 522 and computer system-1B 524 opening a tab in shared tab group A by opening a browser application and/or causing the browser application (e.g., at 530-532) to execute in the foreground.

Turning to FIG. 6, personal connection 602 (e.g., corresponding to the personal connection between computer system-1A 522 and computer system-1B 524) is illustrated between computer system-1A 522 and computer system-1B 524 to show that a connection between computer system-1A 522 and computer system-1B 524 has been established. In some examples, personal connection 602 is established via synchronization server 312 of FIG. 3 rather than identity server 314 of FIG. 3. In some examples, personal connection 602 is a peer-to-peer connection that enables computer system-1A 522 and computer system-1B 524 to communicate directly with each other. In some examples, personal connection 602 is a client-server connection, where computer system 522-524 use synchronization server 312 of FIG. 3 to communicate with each other via notifications, such as push notifications that originate from one of the computer systems and is pushed via synchronization server 312 of FIG. 3 to the other computer system.

Turning back to FIG. 5A, in some examples, computer system-1A 522 and computer system-1B 524 maintain and/or establish a connection with identity server 314 of FIG. 3 upon computer system-1A 522 and computer system-1B 524 opening the tab in shared tab group A by opening a browser application and/or causing the browser application to operating in the foreground (e.g., at 530-532). In some examples, computer system-1A 522 and computer system-1B 524 are concurrently connected via personal connection 602 of FIG. 6 and are individually connected to identity server 314 of FIG. 3. In some examples, personal connection 602 of FIG. 6 allows computer system-1A 522 and computer system-1B 524 to communicate faster than via their individual connection to identity server 314 of FIG. 3 (e.g., for similar reasons as provided above). Thus, in some examples, messages sent via personal connection 602 allows computer system-1A 522 and/or computer system-1B 524 to provide functionality and/or perform one or more operations, such as updating user interface elements, faster than messages sent via a connection to identity server 314 of FIG. 3 enables the computer systems to provide and/or perform. In some examples (and as further described below), a computer system sends “presence data” via one or more personal and/or shared connections (e.g., via synchronization server 312 of FIG. 3) while computer system sends “data that is not presence data” via one or more connections to identity server 314 of FIG. 3. In some examples, presence data is data that corresponds to a user's interaction with content, so a computer system sends the “presence data” via a personal and/or shared connection (e.g., via synchronization server 312 of FIG. 3) so that one or more other computer systems can respond quicker to interactions at a respective computer system.

As used herein, the term “personal connection” is a connection between the personal computer systems associated with a user (e.g., such as user 1, who is associated with computer system-1A 522 and computer system-1B 524 as discussed above). In some examples, at 530-534, computer system-1A 522 and computer system-1B 524 can establish the personal connection due to different criteria when computer system-1A 522 and computer system-1B 524 are different types of devices. In some examples, a computer system will establish a personal connection to other computer systems associated with the same user as the computer system when it is determined that the computer system is a mobile device, such as mobile phone, tablet, and/or a computer system with a display that is the size of a typical mobile phone and/or tablet or smaller, and a browser application including the shared tab groups is executing in the foreground. However, the computer system will not establish the personal connection to the other computer systems when it is determined that the computer system is a mobile device and the browser application (e.g., that includes the shared tab groups) is executing in the background. However, in some examples, the computer system will establish the personal connection to the other computer systems as long as the browser application is executing, irrespective of whether the browser application is executing in the foreground or the background, when the computer system is a desktop and/or laptop (e.g., with a display screen that is bigger than the size of a typical mobile phone's and/or device's display and/or a display that is intended and/or designed to be better at multi-tasking than a mobile phone's and/or device's display). Thus, in some examples, a computer system that is connected to other computer systems of a user via a personal connection will disconnect with the other computer systems when the computer system is a mobile device and a determination is made that the browser application has transitioned from executing in the background to executing in the foreground (but, in some examples, not when the computer system is a laptop and/or desktop). In some examples, a computer system that is connected to other computer systems of a user via a personal connection will disconnect with the other computer systems when the browser application stops executing, irrespective of whether the computer system is a mobile device or another type of device. In some examples, a computer system determines whether a computer system is a certain type of device based on the operating system that is used to execute the browser application running on the computer system, such as a mobile phone operating system, a tablet operating system, a laptop operating system, a desktop operating system, a head-mounted display operating system, and/or a fitness tracking device operating system.

At 538, computer system-1A 522 establishes a shared connection to one or more computer systems with which shared tab group A is shared via shared tab group activity A 512 (e.g., using one or more techniques described above in relation to activity sessions of FIG. 3). Computer system-1A 522 establishes the shared connection with shared tab group A in response to user 1 opening a tab in shared tab group A at 530 using computer system-1A 522 (and/or computer system-1A 522). Moreover, at 540, computer system-1B 524 establishes a shared connection to one or more computer systems with which shared tab group B is shared via shared tab group activity B 514 (e.g., using one or more techniques described above in relation to activity sessions of FIG. 3). Similar to computer system-1A 522, computer system-1B 524 establishes the shared connection with shared tab group B in response to user 1 opening a tab in shared tab group B at 532 using computer system-1B 524 (and/or computer system-1B 524).

At 542, computer system-3 526 opens a tab in shared tab group B and establishes a shared connection to one or more computer systems with which shared tab group B is shared via shared tab group activity B 514 at 544 (e.g., using one or more techniques described above in relation to activity sessions of FIG. 3). Similar to computer system-1B 524, computer system-3 526 established the shared connection with shared tab group B in response to computer system-1B 524 opening a tab in shared tab group B at 542. Thus, at 544, computer system-1B 524 and computer system-3 526 are connected via a shared connection, which is shown by shared connection 606 of FIG. 6.

As used herein, the term “shared connection” is a connection between computer systems of one or more different users and/or members of a shared tab group (e.g., users with which a shared tab group is shared). Like a personal connection, the shared connection can be a peer-to-peer connection and/or a client-server connection via synchronization server 312 of FIG. 3 and can provide faster communication between computer systems than a connection provided via identity server 314 of FIG. 3. In some examples, any computer system that communicates via the shared connection also communicates via a connection with identity server 314 of FIG. 3 and/or via its own individual personal connection with one or more computer systems associated with its user. In some examples, computer system-3 526 does not establish a personal connection with computer system-1B 524 because computer system-3 526 and computer system-1B 524 are not associated with the same user. Rather, these computer systems are associated with different users (e.g., user 3 and user 1).

Similar to computer system-3 526, at 546, computer system-2 520 opens a tab in shared tab group A and establishes a shared connection to one or more computer systems with which shared tab group A is shared via shared tab group activity A 512 at 548 (e.g., using one or more techniques described above in relation to activity sessions of FIG. 3). Similar to computer system-1A 522, computer system-2 520 establishes the shared connection with shared tab group A in response to computer system-2 520 opening a tab in shared tab group A at 546. Thus, at 548, computer system-2 520 and computer system-1A 522 are connected via a shared connection, which is shown by shared connection 602 of FIG. 6.

At 550, user 1 switches to viewing and/or interacting with a new tab in shared tab group B using computer system-1B 524. Upon user 1 switching to viewing and/or interacting with a new tab in shared tab group B using computer system-1B 524, the presence of user 1 in relation to shared tab group B is determined to have changed because user 1 is viewing a new tab in shared tab group B. Thus, at 552, computer system-1B 524 sends an update message to the computer systems associated with the users with which shared tab group B is shared via the shared connection with shared tab group activity B 514. Likewise, at 554, computer system-1B 524 sends an update message via the personal connection to update computer system-1A 522 (and, in some examples, other computer systems associated with user 1) concerning the presence of user 1 changing in relation to shared tab group B. In some examples, the update messages (e.g., which includes presence data) sent via computer system-1B 524 are only sent via the personal and/or shared connections of computer system-1B 524 (e.g., via, in some examples, connections to synchronization server 312) and are not sent via a connection to identity server 314 of FIG. 3. In some examples, data other than presence data is sent to identity server 314 of FIG. 3 and not sent via the personal and/or shared connections of computer system-1B 524 (e.g., via, in some examples, connections to synchronization server 312). In some examples, the update message at 552 is sent before, after, and/or simultaneously with the update message at 554.

At 556, computer system-3 526 receives the update message sent at 552, and computer system-1A 522 receives the update message sent at 554. Here, the content (and/or payload) of the message sent at 552 is the same as the content sent at 554, where the contents of both messages indicate a tab group identifier (e.g., identifier associated with tab group B) and a tab identifier pair representing what tab in which group that a user changed from and/or changed to). In some examples, after computer system-3 526 receives the update message at 556, computer system-3 526 updates an indicator of the presence of user 1 (e.g., user indicator 440 or user indicator 442 of FIG. 4B), such that the indicator of the presence of user 1 moves from the tab that user 1 was viewing and/or interacting with to the tab that user 1 started viewing and/or interacting with at 550.

At 558, computer system-1A 522 receives the update message sent at 554 and sends a different update message to the computer systems associated with the users with which shared tab group A is shared via the shared connection with shared tab group activity A 512 at 560. In some examples, computer system-1A 522 sends the update message at 560 because a determination is made that computer system-1B 524 could not directly send a message because computer system-1B 524 is not connected to the computer systems associated with the users with which shared tab group A is shared. In some examples, the update message received at 558 by computer system-1A 522 is different than the update message sent at 560 (and/or the update message sent at 552) by computer system-1A 522 because users with which shared tab group activity A is shared may not know about shared tab group activity B and/or particular information concerning shared tab group activity B, including identifiers associated with shared tab group activity B and/or the tabs of shared tab group activity B. In some examples, the update message sent at 560 includes content (and/or a payload) that indicates that user 1 has left (e.g., left shared tab group activity A) and/or that the presence of user 1 is no longer detected in relation to shared tab group activity A without identifying identifiers related to shared tab group activity B, including a tab group identifier (e.g., identifier associated with tab group B) and a tab identifier pair representing what tab in which group that a user changed from and/or changed to). In some examples, after computer system-2 520 receives the update message sent at 562, computer system 620 updates an indicator of the presence of user 1 (e.g., user indicator 440 or user indicator 442 of FIG. 4B), such that the indicator of the presence of user 1 is no longer displayed (e.g., because user 1's presence is not detected with regards to shared tab group activity A based on user 1 using computer system-1B to switch tabs in shared tab group B at 550).

Turning to FIG. 5B, at 564, after sending the update message at 560, computer system-1A 522 disconnects from the shared connection that was established with shared tab group A at 538 of FIG. 5A (e.g., disconnects from shared tab group activity A). Computer system-1A 522 disconnects from the shared connection that was established with shared tab group A because the determination was made that the presence of user 1 was detected at shared tab group B at 550. On the other hand, at 566, computer system-2 520 remains connected to the shared connection with shared tab group A (e.g., including other users that shared tab group A is shared without regards to users 1 and 3). Notably, the presence of user 1 is determined based on the latest and/or recent interaction using any computer system associated with the user received with regards to interacting with a shared tab group. Thus, in some examples, even if computer system-1A 522 was still displaying a webpage of a tab in shared tab group A while and after user 1 used computer system-1B to switch tabs in shared tab group B at 550, the presence of user 1 being detected in relation to the interaction with a tab in shared tab group B would cause the computer systems of users belonging to shared tab group A to be updated and cease to display user 1 as being present in relation to a tab in shared tab group A.

At 570, user 1 switches to viewing and/or interacting with a new tab (e.g., a different tab than the one at 550) in shared tab group B using computer system-1B 524. At 572-574, computer system-1B 524 sends update message 572-574 concerning the new tab using one or more similar techniques described above in relation to 552-554. At 576, computer system-1A 522 receives the update message but does not forward the update message and/or send a message to any other computer systems because computer system-1A 522 no longer has a shared connection with any shared tab groups (e.g., after disconnecting from shared tab group A at 564). At 578, computer system-3 526 receives update message and, in response to receiving update message, performs one or more operations (e.g., changing display of a user indicator) similar to those described above in relation to 556 of FIG. 5A.

It should be understood that an interaction with a tab also includes and/or could be referred to as an interaction with a webpage represented by the tab, such as scrolling a webpage, selecting text, inserting text, moving a cursor, and/or playing media in relation to the webpage. It should also be understood that one or more steps provided in FIGS. 5A-5B could occur in response to an interaction with a tab or webpage that is different from switching tabs, such as the interaction described in relation to interacting with a webpage. It should also be understood that sharing a group of content other than tabs could also be encompassed by the techniques described above, including sharing different groups of slides with different sets of users for a presentation, sharing different workbooks with different sets of users for a spreadsheet document, and/or sharing different sections with different sets of users for a word processing document.

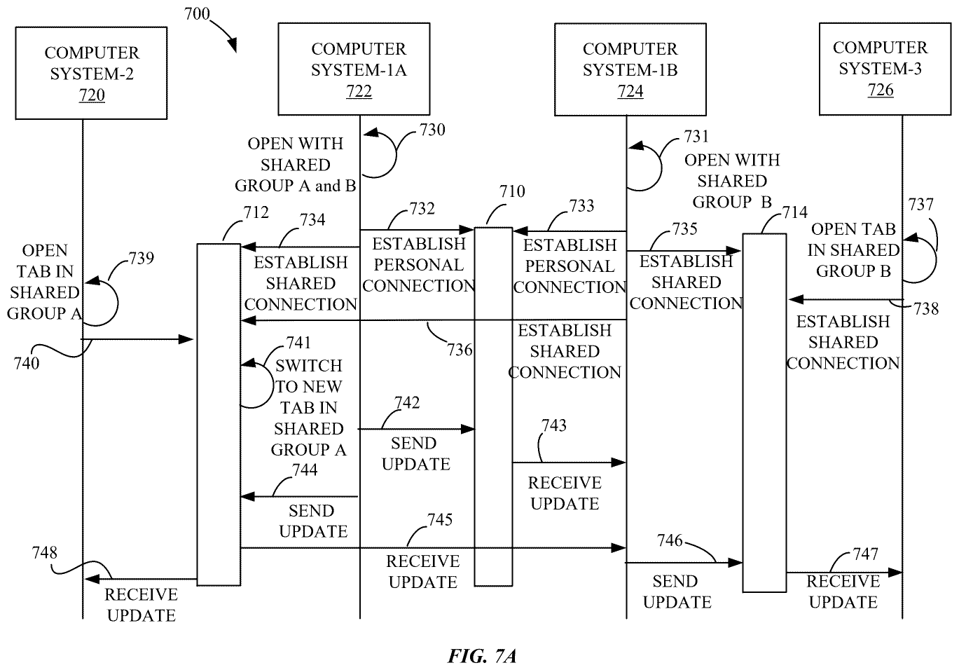

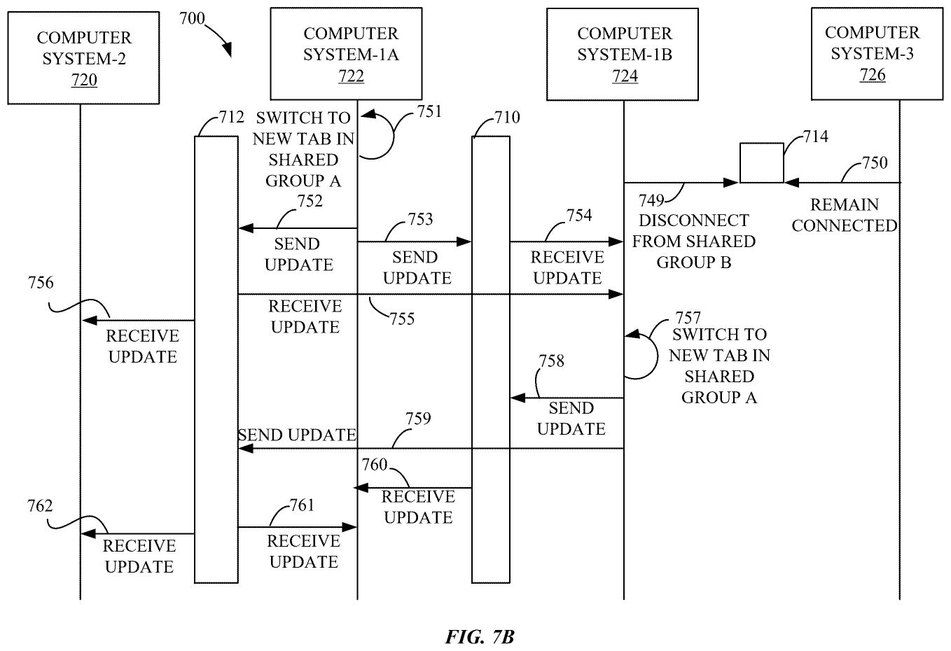

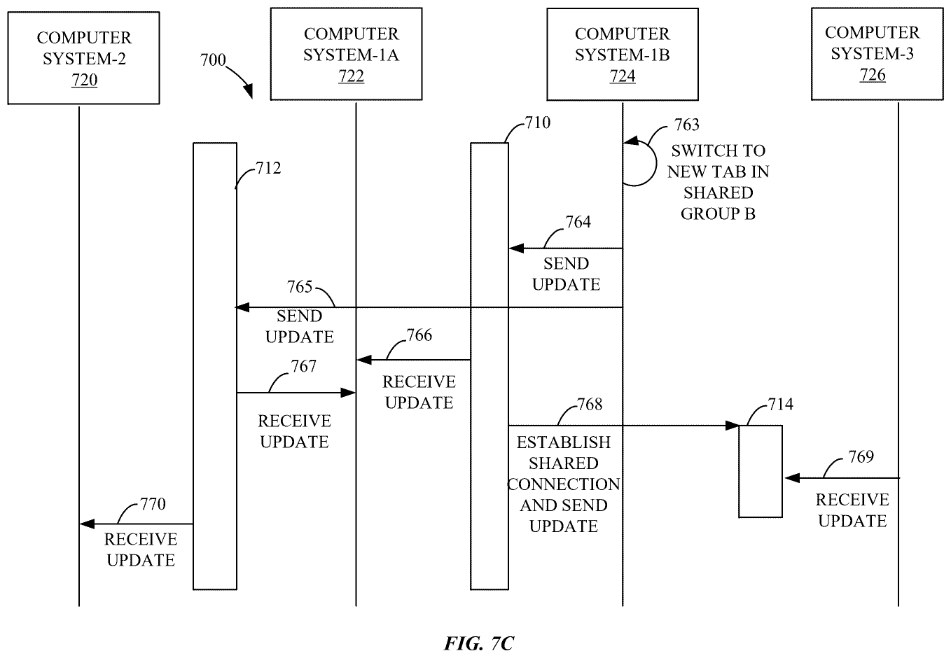

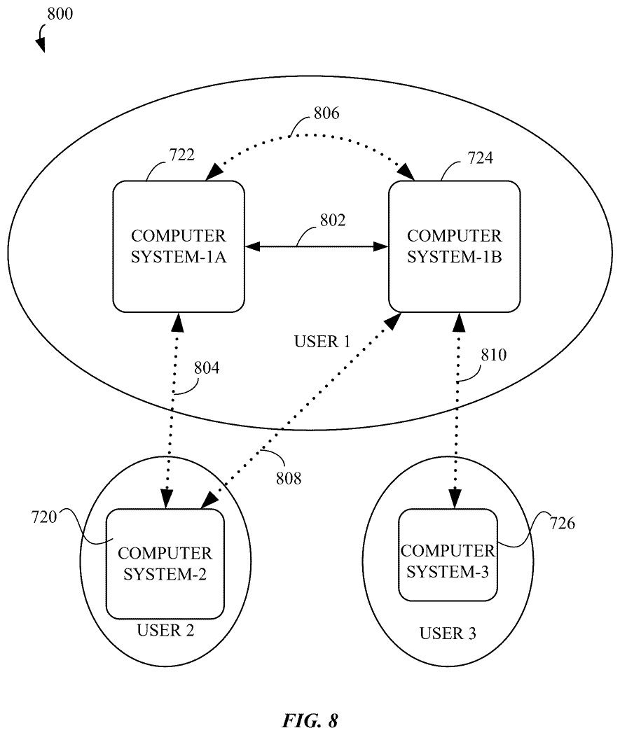

FIGS. 7A-7C are exemplary lane diagram 700 for managing communication between computer systems in accordance with some examples, and FIG. 8 is exemplary block diagram 800 representing connections between computer systems in accordance with some examples. In particular, FIG. 8 is provided to show the connections between computer system-2 720, computer system-1A 722, computer system-1B 724, and computer system-3 726 that are made while one or more steps of FIGS. 7A-7C occur. Computer system-2 720 is a computer system that is associated with user 2 discussed above in relation to FIG. 3 and includes one or more characteristics of computer system 320 of FIG. 3. Computer system-1A 722 and computer system-1B 724 are computer systems that are associated with user 1 discussed above in relation to FIG. 3 and include one or more characteristics of computer system 322 and computer system 324 of FIG. 3, respectively. Computer system-3 726 is a computer system that is associated with user 3 discussed above in relation to FIG. 3 and includes one or more characteristics of computer system 326 of FIG. 3. In some examples, one or more of computer systems 722-726 include one or more characteristics of compute system 100 of FIG. 1 and/or device 200 of FIG. 2.

Turning to FIG. 7A, at 730-732, computer system-1A 722 and computer system-1B 724 opens a tab in shared tab group A and/or B by opening a browser application and/or causing the browser application to execute in the foreground and establish a personal connection with each other using one or more techniques described above in relation to 530-536 of FIG. 5A. Turning to FIG. 8, the personal connection established between computer systems 722-724 is represented by personal connection 802.

Turning back to FIG. 7A, at 730, computer system-1A 722 opens a browser application and/or causes the browser application to execute in the foreground and establishes a shared connection with shared tab group A at 734, using one or more techniques described above in relation to 538 of FIG. 5A because the browser application of computer system-1A 722 includes a tab in shared tab group A.

At 731, computer system-1B 724 opens a browser application and/or causes the browser application to execute in the foreground and establishes a shared connection with shared tab group B at 735, using one or more techniques described above in relation to 540 of FIG. 5A because the browser application of computer system-1B 724 includes a tab in shared tab group A. At 731, computer system-1B 724 does something that was not presented in relation to FIGS. 5A-5B. At 731, computer system-1B 724 opens the browser application and/or causes the browser application to execute in the foreground and establishes a shared connection with shared tab group A at step 736 because the browser application of computer system-1B 724 also includes a tab in shared tab group A (e.g., in addition to shared tab group B discussed above). Because computer system-1A 722 and computer system-1B 724 have shared connections to shared tab group A via shared tab group activity A 712, computer system-1A 722 and computer system-1B 724 have both shared and personal connections with each other (e.g., as shown by personal connection 802 and shared connection 806 in FIG. 8).

At 737, computer system-3 726 opens a tab in shared tab group B and establishes a shared connection to one or more computer systems with which shared tab group B is shared via shared tab group activity B 714 at 738, using one or more techniques described above in relation to 542-544 of FIG. 5A. Turning to FIG. 8, shared connection 810 is provided between computer system-1B 724 and computer system-3 726 to show that they have a shared connection to each other.

Turning back to FIG. 7A, at 739, computer system-2 720 opens a tab in shared tab group A and establishes a shared connection to one or more computer systems with which shared tab group A at 740. Because shared tab group A is being shared with computer system-1A 722 and computer system-1B 724 (e.g., as discussed above), computer system-2 720 has a shared connection with each of computer system-1A 722 and computer system-1B 724 (e.g., via shared tab group A activity 712), which is shown by shared connection 804 and 808 in FIG. 8.

At 741, user 1 uses computer system-1A 722 to switch to a new tab in shared tab group A. At 742, computer system-1A 722 sends an update message via the personal connection, and sends an update message at 744 via the shared connection with shared tab group A to let other computer systems know that the presence of user 1 has changed. Here, the update messages sent at 742-744 are similar in that they include a tab group identifier (e.g., identifier associated with tab group A) and a tab identifier pair (e.g., with an identifier for shared tab group A and an identifier corresponding to the tab that was switched from and/or to). Here, the update messages sent at 742-744 are similar because computer system-1A 722 has a shared connection with shared tab group A and has a personal connection with computer system-1B 724.

At 743, computer system-1B 724 receives the update message sent at 742 (e.g., via the personal connection). Moreover, at 745, computer system-1B 724 also receives the update message sent at 744 (e.g., via the shared connection). Computer system-1B 724 received both messages from computer system-1A 722 because computer system-1B 724 has a shared connection and a personal connection with computer system-1A 722. Computer system-1B 724 can process receiving multiple update messages differently. At FIGS. 7A-7C (and also at FIGS. 5A-5B discussed above), update messages can include conflict-free replicated data types (e.g., CRDTs), which can be used to resolve conflicts between message updates (e.g., receiving multiple messages about the presence data). In some examples, the CRDTs include a clock that is a monotonously incrementing integer, where a higher number indicates a more recent message. In some examples, the CRDTs include a clock that is monotonously decrementing integer, where a lower number indicates a more recent message. In some examples, the CRDTs includes a device identifier, which indicates the current state of a respective user for whom a message concerns. In some examples, a respective computer system keeps track of the latest and/or most recent messages received by the computer system. In some examples, a received update message with a lower CRDT generation than locally known is discarded while a received update message with a higher CRDT generation will replace a locally known update message (and/or previously stored update message). In some examples, the replacement of a received update message with a locally known update message will cause a user interface to be updated (e.g., because the presence of a user has been updated).

At FIG. 7A, if the update message sent at 742 is received before the update message at 744, computer system-1B 724 will send an update message corresponding to the update message sent at 742 to shared tab group B and discard the update message sent at 744 after determining that the update message sent at 742 is equal to the update message sent at 744. In other examples, if the update message sent at 744 is received before the update message sent at 742, computer system-1B 724 will send an update message corresponding to the update message sent at 744 to shared tab group B and discard the update message sent at 742 after determining that the update message sent at 742 is equal to the update message sent at 744. At 746, an update message corresponding to one of the update message sent at 742 and the update message sent at 744 is sent via the shared connection with shared tab group B. At 747, computer system-3 726 receives the update message, which does not include as much information as the update message sent at 742 and/or 744 (e.g., because computer system-1A 722 is not a part of shared tab group B and for similar reasons described above in relation to 558-560). In some examples, after receiving the update message at 747, computer system-3 726 performs similar operations to those described above in relation to 556 and/or 562, including removing display of a user indicator for user 1.

At 748, computer system-2 720 receives update message sent at 744 (e.g., to shared tab group A). Here, the update message received at 748 includes more information because computer system-1A 722 is a part of the shared tab group A. In some examples, after receiving the update message at 748, computer system-2 720 performs similar operations to those described above in relation to 556 and/or 562, including moving the user indicator for user 1 to a different tab. Turning to FIG. 7B, at 749, computer system-1B 724 disconnects from shared tab group A, and computer system-3 726 remains connected to shared tab group B at 750, using one or more techniques described above in relation to 566-564, respectively.

At 751, user 1 uses computer system-1A 722 to switch to a new tab in shared tab group A. At 752-753, computer system-1A 722 sends update messages, using one or more similar techniques discussed above in relation to 741, 742, and 744. At 754, computer system-1B 724 receives the update message sent at 753, and, at 755, computer system-1B 724 also receives the update message sent at 752 for one or more similar reasons discussed above in relation to 754-755. Computer system-1B 724 will store the first received update message locally and discard the other message (e.g., for similar reasons as described above in relation to 752-754). However, after storing the first receive message locally, computer system-1B 724 will not send a message concerning the first update message to a shared connection because computer system-1A 722 sent the update message and is also currently connected to shared tab group A along with computer system-1B 724. In some examples, it is assumed that computer system-1A 722 sent an update message to all of the shared connections for computer system-1A 722. In some examples, computer system-1B 724 avoids sending a duplicate message via this assumption.

At 756, computer system-2 720 receives update message sent at 752 (e.g., to shared tab group A). In some examples, after receiving the update message at 756, computer system-2 720 performs similar operations to those described above in relation to 556 and/or 562, including moving the user indicator for user 1 to a different tab.

At 757, user 1 uses computer system-1B 724 to switch to a new tab in shared tab group A. At 758-759, computer system-1B 724 sends an update message via the personal and shared connections of computer system-1A 722, using similar techniques as discussed above in relation to 742-744. Moreover, at 760, computer system-1A 722 receives the message sent at 758 (e.g., a personal connection), and, at 761, computer system-1A 722 receives the message sent at 759 (e.g., via a shared connection). Here, computer system-1A 722 will keep one of the received messages and discard the other received message, using similar techniques as discussed above in relation to 754 and 755. At 762, computer system-2 720 receives update message sent at 759 (e.g., to shared tab group A). In some examples, after receiving the update message at 762, computer system-2 720 performs similar operations to those described above in relation to 556 and/or 562, including moving the user indicator for user 1 to a different tab.

Turning to FIG. 7C, at 763, user 1 uses computer system-1B 724 to switch to a new tab in shared tab group B. At 764-765 computer system-1B 724 sends update messages, using one or more similar techniques discussed above in relation to 741, 742, and 744. After update messages are sent at 764-765, computer system-1A 722 receives the update message sent at 764 (e.g., via personal connection) and the update message sent at 765 (e.g., via shared connection with shared tab group A) at 766 and 767, respectively. In examples where the update message sent at 764 (e.g., via personal connection) is received before the message sent at 765 (e.g., via shared connection with shared tab group A), computer system-1A 722 saves the message sent at 764 (e.g., because it has more information, user selected a particular tab in a particular tab group) and discards the update message sent at 765 (e.g., because it has less information, user left). In examples where the update message sent at 764 (e.g., via personal connection) is received after the message sent at 765 (e.g., via shared connection with shared tab group A), computer system-1A 722 saves the message sent at 765 at first, but discards the message sent at 765 when the update message sent at 764 is received (e.g., because the update message sent at 765 the same generation as the update message sent at 764 but the update message at 764 has more information than the update message sent at 765). In some examples, computer system-1A 722 does not forward any received messages with regards to 764-765 because computer system-1A 722 and computer system-1B 724 are disconnected from the shared connection for shared tab group A since the presence of user 1 is now detected at shared group B (e.g., because computer system-1B 724 was used to switch to a new tab in shared tab group B at 763).

At 768, computer system-1B 724 establishes (and/or re-establishes) a shared connection with shared tab group B (e.g., because computer system-1B 724 was used to switch to a new tab in shared tab group B at 763) and sends via the shared connection (e.g., via shared tab group activity 714). At 769, computer system-3 726 receives the update message. In some examples, computer system-3 726 performs similar operations to those described above in relation to 556 and/or 562, including showing a user indicator for user 1 on a tab (e.g., where a user indicator was not previously displayed before 763 occurred because a connection was not shared with shared tab group B). At 770, computer system-2 receives the update message sent at 765 and stops displaying a user indicator for user 1, using one or more techniques described in relation to 556 of FIG. 5A)

It should be understood that an interaction with a tab also includes and/or could be referred to as an interaction with a webpage represented by the tab, such as scrolling a webpage, selecting text, inserting text, moving a cursor, and/or playing media in relation to the webpage. It should also be understood that one or more steps provided in FIGS. 7A-7C could occur in response to an interaction with a tab or webpage that is different from switching tabs, such as the interaction described in relation to interacting with a webpage. It should also be understood that sharing a group of content other than tabs could also be encompassed by the techniques described above, including sharing different groups of slides with different sets of users for a presentation, sharing different workbooks with different sets of users for a spreadsheet document, and/or sharing different sections with different sets of users for a word processing document.

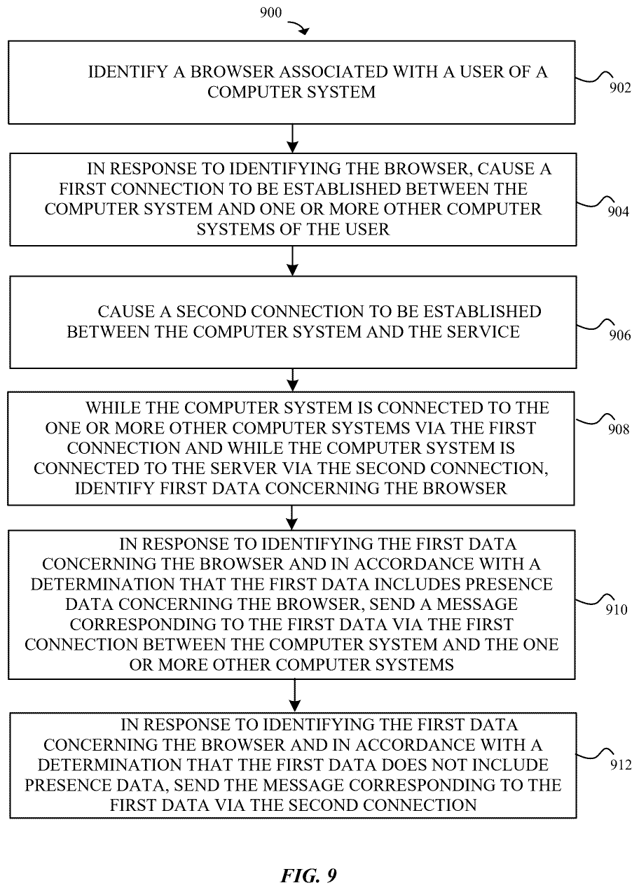

FIG. 9 is a flow diagram illustrating a method (e.g., method 900) for managing personal communications between computer systems of a user in accordance with some examples. Some operations in method 900 are, optionally, combined, the orders of some operations are, optionally, changed, and some operations are, optionally, omitted.

As described below, method 900 provides an intuitive way for managing personal communications between computer systems of a user. Method 900 reduces the cognitive burden on a user for managing personal communications between computer systems of a user, thereby creating a more efficient human-machine interface. For battery-operated computing devices, enabling a user to manage personal communications between computer systems of a user faster and more efficiently conserves power and increases the time between battery charges.

At 902, the computer system identifies (e.g., navigate to, open, view, detect input corresponding to, acquire, obtain, choose, select, and/or receive information concerning) a browser (e.g., a web browser and/or a document window) associated with (e.g., that was opened by, that is being used by, that was set up by, and/or that was displayed on a computer system corresponding to, belonging to, and/or of) a user of (e.g., and/or a user account associated with, registered with, logged into, on, and/or via) a computer system. In some examples, the computer system is a phone, a watch, a tablet, a fitness tracking device, a wearable device, a television, a multi-media device, an accessory, a speaker, a head-mounted display (HMD), a service, a backend process, and/or a personal computing device. In some examples, the computer system is in communication with input/output devices, such as one or more cameras, speakers, microphones, and/or sensors (e.g., heart rate sensor, monitors, Bluetooth, near-field communication sensors, and/or Wi-Fi sensors). In some examples, the webpage is identified after the computer system joins and/or is invited to an activity session (e.g., a unique session associated with a shared tab group and/or subset that is accessible to multiple users) associated with a data object (e.g., saved file stored on a remote device (e.g., in the cloud and/or a server)). In some examples, the browser includes a webpage (e.g., a page of a browser, a tab denoting a webpage and/or browser window in a web browser, a tab denoting a page and/or window of content in an application (e.g., a document generating application, a web browser, a presentation application, and/or a spreadsheet application) (and, in some examples, a browser component (e.g., one or more user interface elements and/or content of a browser))).

At 904, in response to identifying the browser, the computer system causes a first connection (e.g., a channel, a communication channel, a data channel, and/or a data connection) to be established (e.g., provided, set up, and/or configured) between the computer system and one or more other computer systems (e.g., one or more types of computer systems described above in relation to the computer system) of the user. In some examples, the computer system is a different type of computer system than the one or more other computer systems. In some examples, the computer system is in the same location, region, geo-locations, building, house, store, vehicle, and/or area as the one or more other computer systems. In some examples, the computer system is in a different location, region, geo-locations, building, house, store, vehicle, and/or area as the one or more other computer systems (e.g., when, before, and/or after the connection is set up between the computer system and the one or more other computer systems). In some examples, the computer system and the one or more other computer systems are registered and/or connected to an account for the user and/or corresponding to the user. In some examples, setting up the connection includes establishing a communication channel (e.g., “a real-time” channel) for syncing (e.g., directly with no intermediary computer systems and/or directly with one or more intermediary computer systems that pass along the message (e.g., with and/or without manipulating the message) instead of syncing with the storage resource) between one or more computer systems, sending one or more messages between one or more computer systems, and/or linking one or more computer systems. In some examples, the connection is established through an activity that is accessible to the one or more other computer systems of the user and the computer system (and, in some examples, not accessible to another computer system). In some examples, the activity is hosted on a server (and, in some examples, a cloud server), such as an identity server that knows the identity of the user and/or one or more other users. In some examples, a computer system determines that the webpage is shared with one or more users other than the user of the computer system. In some examples, a computer system determines that the webpage is not shared with one or more users (e.g., a second user, a third user, and/or the like) other than the user of the computer system.

At 906, the computer system causes a second connection (e.g., a channel, a communication channel, a data channel, and/or a data connection) to be established (e.g., provided, set up, and/or configured) between the computer system and a service (e.g., an identity, synchronization, and/or intermediary service) (e.g., without sending the first data via the first connection between the computer system and the one or more other computer systems) (e.g., a service that knows and/or keeps track of the identity of the user and/or one or more other users and/or account information associated with the user and/or one or more other users) (and, in some examples, without sending the message via the first connection (and/or any connection) between the computer system and the one or more other computer systems), wherein the second connection is different from the first connection. In some examples, the service is not a part of the one or more other computer systems and/or is not a computer system of the user and/or of only the user. In some embodiments, the first connection and second connection are caused to be established after and/or in response to opening the webpage and/or opening a web browser application that includes the webpage. In some examples, data communicated via the first connection is communicated faster with an endpoint device (e.g., a computer system that is sharing a webpage and/or document with another user) than data communicated via the second connection. In some embodiments, the service is provided via a server. In some embodiments, the second connection is a peer-to-peer connection.

At 908, while the computer system is connected to the one or more other computer systems via the first connection and while the computer system is connected to the service via the second connection, the computer system identifies first data concerning the browser.

At 910, in response to identifying the first data concerning the browser and in accordance with a determination that the first data includes presence data (e.g., data identifying and/or denoting whether a user is using (e.g., interacting with, viewing, editing, reading, and/or updating) a webpage and/or web component) concerning the browser, the computer system sends (e.g., transmit and/or move) a message corresponding to (e.g., including and/or associated with) the first data via the first connection between the computer system and the one or more other computer systems.

At 912, in response to identifying the first data concerning the browser and in accordance with a determination that the first data does not include presence data, the computer system sends the message corresponding to the first data via the second connection. In some examples, in response to identifying the first data and in accordance with a determination that the first data is the first type of data, the message is sent via the first connection without sending the first data via the second connection. In some examples, in response to identifying the first data and in accordance with a determination that the first data is the first type of data, the message is sent via the first connection and the second connection.

In some examples, the first connection is a peer-to-peer connection. In some examples, the first connection enables the computer system to send first one or more messages to the one or more other computer systems. In some examples, the first connection is a direct connection to the one or more other computer systems.

In some examples, the first connection includes a client-server connection. In some examples, the client-server connection includes: a first client-server connection between the computer system and a server (e.g., a synchronization server); and a second client-server connection between another computer system of the one or more other computer systems and a server, where the server manages distribution of data via the client-server connection.

In some examples, the computer system is connected to the one or more other computer systems via the first connection between the computer system and the one or more other computer systems while being concurrently connected to the server via the second connection between the computer system and the server.

In some examples, after detecting the presence of the user with respect to the browser and while the first connection between the computer system and the one or more other computer systems is established, the computer system detects that the presence of the user is no longer detected with respect to the browser. In some examples, in response to detecting that the presence of the user is no longer detected with respect to the browser, the computer system causes the first connection between the computer system and the one or more other computer systems to be terminated (e.g., to be disconnected and/or without maintaining a connection between the computer system and the one or more other computer systems) (and, in some examples, while causing a connection between the computer system and an identity server to be disconnected).

In some examples, the presence of the user is not detected (e.g., non-presence of the user is detected) while the browser is operating (e.g., running and/or executing) in the background (e.g., as a background process and/or not viewable and/or visible). In some examples, the presence of the user is detected while the browser is operating in the foreground (e.g., as a foreground process and/or viewable and/or visible) (e.g., when the computer system is a mobile computer system, such as a mobile phone and/or a fitness tracking device, such as a smart watch). In some examples, when the computer system is a computer system, such as a tablet, laptop, and/or desktop, the presence of the user continues to be detected while the browser is operating in the background.

In some examples, the presence of the user is not detected (e.g., non-presence of the user is detected) in response to the browser application including (e.g., hosting and/or used to display) the browser being exited (e.g., closed and/or ceasing to execute and/or operate) (e.g., when the computer system is a computer system, such as a tablet, laptop, and/or desktop).

Note that details of the processes described above with respect to method 900 (e.g., FIG. 9) are also applicable in an analogous manner to other methods described herein. For example, method 1000 optionally includes one or more of the characteristics of the various methods described above with reference to method 900. For example, the techniques of method 900 can be used to manage communication between personal computing devices and a server to send different types of data, where some of the types of data can be also sent utilizing the method and techniques of method 1000 to other devices. For brevity, these details are not repeated below.

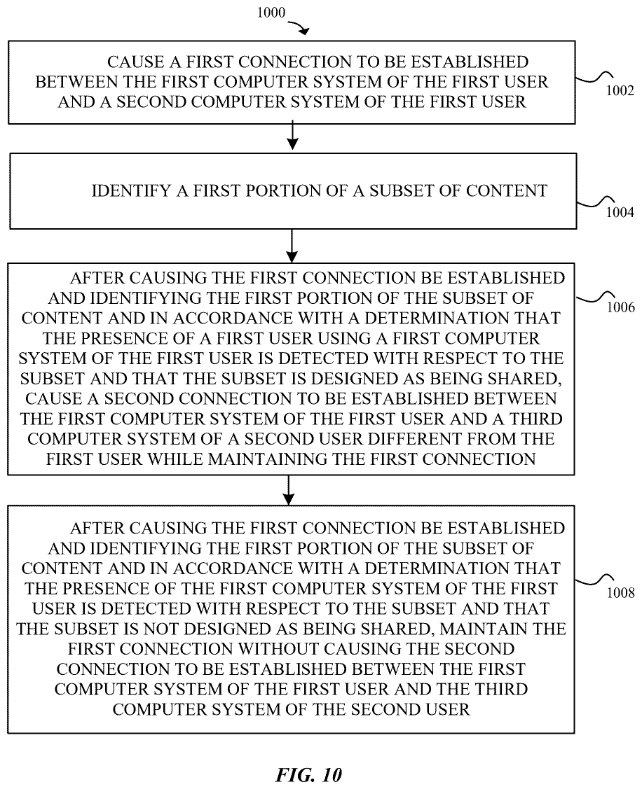

FIG. 10 is a flow diagram illustrating a method (e.g., method 1000) for managing communication between computer systems with respect to shared content in accordance with some examples. Some operations in method 1000 are, optionally, combined, the orders of some operations are, optionally, changed, and some operations are, optionally, omitted.

As described below, method 1000 provides an intuitive way for managing communication between computer systems with respect to shared content. Method 800 reduces the cognitive burden on a user for managing communication between computer systems with respect to shared content, thereby creating a more efficient human-machine interface. For battery-operated computing devices, enabling a user to manage communication between computer systems with respect to shared content faster and more efficiently conserves power and increases the time between battery charges.

At 1002, the computer system causes a first connection (e.g., as described above in relation to method 900) (e.g., a connection between the personal computer systems (e.g., identified personal computer systems, such as computer systems being registered with the same account and/or group of accounts) for the first user) to be established (e.g., as described above in relation to method 900) between the first computer system of the first user and a second computer system (e.g., as described above in relation to method 900) of the first user.

At 1004, the computer system identifies (e.g., navigate to, open, view, detect input corresponding to, acquire, obtain, choose, select, and/or receive information concerning) a first portion (e.g., application content, other content, document, a window, a page, and/or a webpage) of a subset of content (e.g., a group, a collection, a section, a hash, a portion, shared group, shared collection, shared section, shared hash, and/or shared portion of browser tabs (e.g., a tab denoting a webpage and/or browser window in a web browser, a tab denoting a page and/or window of content in an application (e.g., a document generating application, a web browser, a presentation application, and/or a spreadsheet application))).

At 1006, after (e.g., in response to, subsequent to, as a result of, in conjunction with (e.g., immediately after and/or as a part of)) causing the first connection be established and identifying the first portion of the subset of content and in accordance with a determination that the presence of a first user using a first computer system (e.g., as described above in relation to method 900) of the first user is detected with respect to the subset and that the subset is designed as being (e.g., configured to be, established as, and/or set up as) shared (e.g., between the first user and the second user and/or between the first user and any different user), the computer system causes a second connection (e.g., a different connection than the first connection and/or a separate connection from the first connection) (e.g., a connection between the personal computer system of the first user and a personal computer system of the second user) to be established (e.g., as described above in relation to method 900) between the first computer system of the first user and a third computer system (e.g., as described above in relation to method 900) of a second user different from the first user while maintaining the first connection.

At 1008, after causing the first connection be established and identifying the first portion of the subset of content and in accordance with a determination that the presence of the first computer system of the first user is detected with respect to the subset and that the subset is not designed as being shared, the computer system maintains the first connection without causing the second connection to be established between the first computer system of the first user and the third computer system of the second user. In some examples, the first computer system, the second computer system, and/or the third computer system are connected to a service and/or server without being connected to each other and/or while being connected to one of the others via the first connection and/or via the second connection. In some examples, a computer system determines that the presence of the first user using the first computer system of the first user is detected with respect to the subset and that the subset is not designed as being shared. In some examples, the first computer system determines that the presence of the first user using the first computer system of the first user is not detected with respect to the subset and/or that the subset is designed as being shared.

In some examples, while maintaining the first connection and the second connection, the computer system identifies that the presence of the first user has switched from being detected with respect to the first portion of the subset to being detected with respect to the second portion of the subset. In some examples, in response to identifying that the presence of the first user has switched from being detected with respect to the first portion of the subset to being detected with respect to the second portion of the subset, the computer system sends a first message via the first connection and sends a second message via the second connection (and not via the first connection). In some examples, the first message is not sent via the second connection. In some examples, the first message and/or the second message includes an indication that the presence of the first user has switched from being detected with respect to the first portion of the subset to being detected with respect to the second portion of the subset. In some examples, the first message and/or the second message includes an indication that the presence of the first user was previously detected with respect to the first portion of the subset. In some examples, the first message and/or the second message includes an indication that the presence of the first user is detected with respect to the second portion of the subset.

In some examples, content (e.g., a payload and/or information) of the first message is different from content (e.g., a payload and/or information) of the second message (e.g., user A left vs. user A left tab alpha; if computer systems of second connection do not know about tab and/or are not connected to tab alpha, a particular subset, and/or a particular portion of a subset).

In some examples, content (e.g., a payload and/or information) of the first message is the same as content (e.g., a payload and/or information) of the second message (e.g., user A at tab alpha; if computer systems of second connection know about tab and/or are connected to tab alpha, a particular subset, and/or a particular portion of a subset).

In some examples, the first message (and/or content of the first message) is prioritized over the second message (and/or content of the second message) (e.g., irrespective of whether the first message and/or the second message is received first by a receiving computer system) (e.g., messages sent over the first connection are prioritized over messages sent over the second connection) (e.g., messages sent over the first connection are sent before messages sent over the second connection) (e.g., the first message is sent before the second message) (e.g., messages sent over the first connection are processed by receiving computer systems before messages sent over the second connection (e.g., when messages are received approximately simultaneously)) (e.g., the first message is processed by a receiving computer system before the second message is processed by a receiving computer system) (e.g., the first message includes an indication that the first message is higher priority than the second message). In some examples, content of the first message is saved while content of the second message is deleted upon the first message being received (e.g., after the second message is received).

In some examples, one or more of content of the first message and content of the second message includes one or more from the group comprising: identifying information concerning the second portion (e.g., tab location, a web page location (e.g., first webpage in a group, second tab in a group, a third slide in a presentation, and/or fourth section of a document)); media playback information (e.g., information concerning media (e.g., audio and/or video media) being played back and/or a particular media item being played back out of a set of media items included in a webpage, document, and/or in a tab) concerning the second portion; scroll position information (e.g., a position (e.g., horizontal position, vertical position, and/or any combination thereof) that a webpage and/or document is scrolled) concerning the second portion; selected text information (e.g., information concerning text that is concurrently selected in a document and/or on a webpage) concerning the second portion; form text information (e.g., information text that is currently input into a form on a webpage (e.g., an input box, a check mark, a text input element, and/or a password input element)) concerning the second portion; and/or cursor location information (e.g., location of a cursor on a webpage and/or document) concerning the second portion.

In some examples, one or more of content of the first message and content of the second message includes conflict-free replicated data type information.

In some examples, one or more of content of the first message and content of the second message includes time information (e.g., a timestamp and/or an indication of when the message was sent and/or received).

In some examples, the subset is a first subset. In some examples, while maintaining the first connection and the second connection, the computer system identifies that the presence of the first user has switched from being detected with respect to the first subset (e.g., a first group of tabs and/or webpages) to being detected with respect to a second subset of content (e.g., a second group of tabs and/or webpages) that is different from the first subset (e.g., a computer system of the user has clicked on a new tab and/or window, is viewing a new page and/or window, and/or switched between viewing an old tab and/or webpage to a new tab and/or webpage). In some examples, in response to identifying that the presence of the first user has switched from being detected with respect to the first subset to being detected with respect to the second subset, the computer system causes a third connection to be established between the computer system and a fourth computer system (e.g., as described above in relation to method 900) of a third user that is different from the first user and the second user.

In some examples, in response to identifying that the presence of the first user has switched from being detected with respect to the first subset to being detected with respect to the second subset, the computer system maintains the first connection while providing the third connection (e.g., without maintaining and/or causing the second connection to be maintained).

In some examples, a fourth connection to a server (e.g., an identity or synchronization server) is established concurrently with one or more of the first connection and the second connection being established (and, in some examples, irrespective of whether the first connection and/or the second connection are established and/or maintained).

In some examples, the computer system receives a message (e.g., as described below in relation to method 1100). In some examples, in response to receiving the message and in accordance with a determination that the message includes presence data, the computer system sends data corresponding to the message via one or more of the first connection and the second connection without sending data corresponding to the message via the third connection. In some examples, data corresponding to the message sent via the first connection is different from the data corresponding to the message that is sent via the second connection. In some examples, in accordance with a determination that the message does not include presence data, the computer system sends data corresponding to the message via the third connection without sending data corresponding to the message via the first connection and the second connection.

Note that details of the processes described above with respect to method 1000 (e.g., FIG. 10) are also applicable in an analogous manner to other methods described herein. For example, method 1000 optionally includes one or more of the characteristics of the various methods described above with reference to method 900. For example, the techniques of method 900 can be used manage communication between personal computing devices and a server to send different types of data, where some of the types of data can be also sent utilizing the method and techniques of method 1000 to other devices. For brevity, these details are not repeated below.

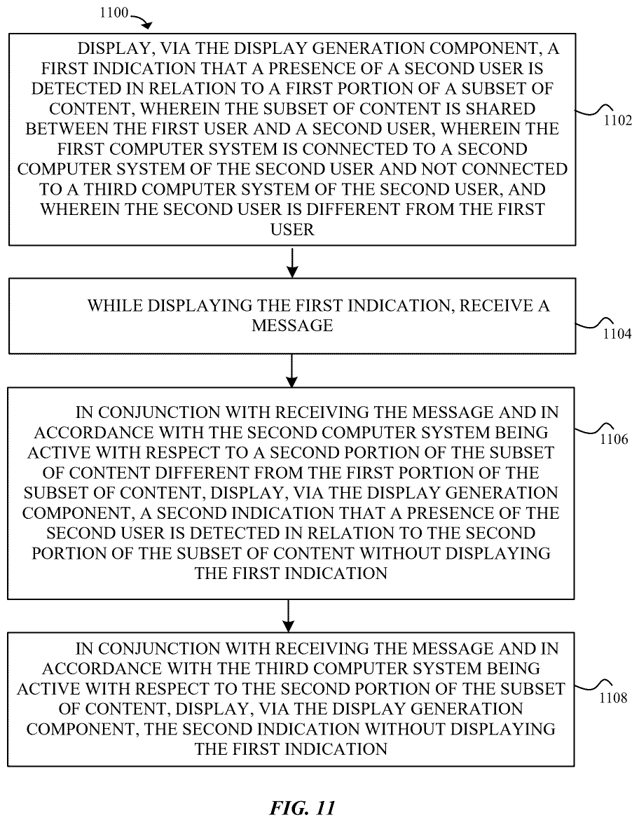

FIG. 11 is a flow diagram illustrating a method (e.g., method 1100) for managing messages with respect to shared content in accordance with some examples. Some operations in method 1100 are, optionally, combined, the orders of some operations are, optionally, changed, and some operations are, optionally, omitted.

As described below, method 1100 provides an intuitive way for managing incoming messages with respect to shared content. Method 1100 reduces the cognitive burden on a user for managing messages with respect to shared content, thereby creating a more efficient human-machine interface. For battery-operated computing devices, enabling a user to manage incoming messages with respect to shared content faster and more efficiently conserves power and increases the time between battery charges.

In some examples, method 1100 is performed by (and/or at) a first computer system that is in communication with a display generation component (e.g., a display, a display area, a touch-sensitive screen and/or display and/or a projector) and that is associated with (e.g., registered with, logged into a first user account associated with, and/or denoted as belonging to) a first user.

At 1102, the first computer system displays, via the display generation component, a first indication that a presence of a second user is detected in relation to a first portion (e.g., a first tab, a first window, a first portion of a section, a first member and/or entity of a collection and/or group, and/or a first item) of a subset of content (e.g., a group, collection, section, hash, portion, shared group, shared collection, shared section, shared hash, and/or shared portion of browser tabs (e.g., a tab denoting a webpage and/or browser window in a web browser, a tab denoting a page and/or window of content in an application (e.g., a document generating application, a web browser, a presentation application, and/or a spreadsheet application)), browser content, documents, document sections, document portions, windows, and/or entities) (e.g., as described above in relation to method 1000), wherein the subset of content is shared between the first user and a second user, wherein the first computer system is connected to a second computer system of the second user and not connected to a third computer system of the second user, and wherein the second user is different from the first user.

At 1104, while displaying the first indication, the first computer system receives a message (e.g., information, data, text, words, symbols, a signal, and/or a request) (e.g., the user has left the subset, the user has stopped using the first portion, the user is using the second portion, and/or the user is using a different subset than the subset) (e.g., a message that has switched tabs and/or entities of a shared group of tabs, as described below in relation to method 900 and method 1000).

At 1106, in conjunction with (e.g., after and/or as a part of) receiving the message (e.g., a message as described above in relation to method 1000), in accordance with (e.g., and/or in accordance with a determination that) the second computer system being active with respect to a second portion of the subset of content different from the first portion of the subset of content (and/or, in some examples, that the second computer system caused the second user to be detected in relation to a second portion of the subset of content different from the first portion of the subset of content (and, in some examples, that the third computer system did not cause the second user to be detected in relation to the second portion)), the first computer system displays, via the display generation component, a second indication that a presence of the second user is detected in relation to the second portion of the subset of content (e.g., the user has left and/or stopped using the first portion and/or the user is using the second portion) without displaying (and/or while ceasing to display and/or without continuing to display) the first indication.

At 1108, in conjunction with receiving the message, in accordance with (e.g., and/or in accordance with a determination that) the third computer system (and/or, in some examples, that the third computer system caused the second user to be detected in relation to the second portion of the subset of content (and, in some examples, that the second computer system did not cause the second user to be detected in relation to the second portion)) being active with respect to the second portion of the subset of content, the first computer system displays, via the display generation component, the second indication without displaying the first indication.

In some examples, the second computer system and the third computer system are in communication with each other (e.g., and/or are connected (e.g., as described above in relation to method 1000) to each other).

In some examples, in conjunction with receiving the message and in accordance with (e.g., and/or in accordance with a determination that) a fourth computer system of a third user, different from the first user and the second user, being active with respect to the second portion of the subset of content, the first computer system displays, via the display generation component, a third indication that a presence of the third user is detected in relation to the second portion of the subset of content while continuing to display the first indication. In some examples, the third indication is visually different from the first indication and/or second indication (e.g., includes an avatar corresponding to the third user than is different from an avatar corresponding to the second user). In some examples, the first indication and/or the second indication includes an avatar of the second user.

In some examples, in accordance with (e.g., and/or in accordance with a determination that) the second computer system being active with respect to the second portion of the subset of content, the message includes a first amount of content. In some examples, in accordance with (e.g., and/or in accordance with a determination that) the third computer system being active with respect to the second portion of the subset of content, the message includes a second amount of content that is less than the first amount of content.

In some examples, the message (e.g., user has switched to the second portion of content, user has switch to a different tab and/or webpage, and/or user has switch to a particular tab and/or webpage) including the first amount of content has location data related to the second portion of the subset of content. In some examples, the message (e.g., user has left and/or is no longer viewing the first portion of the subset of content) including the second amount content does not have location data related to the second portion of the subset of content. In some examples, the message including the first amount of content and the message including the second amount of content has conflict-free replicated data type information and/or time information (e.g., as described above in relation to method 1000).

In some examples, in conjunction with receiving the message and in accordance with (e.g., and/or in accordance with a determination that) the third computer system being active with respect to the second portion of the subset of content, the first computer system forgoes connecting to the third computer system (and, in some examples, while continuing to be connected to the second computer system).

In some examples, in conjunction with receiving the message and in accordance with (e.g., and/or in accordance with a determination that) the second computer system being active with respect to the second portion of the subset of content, the message was received from the second computer system and not the third computer system. In some examples, in accordance with (e.g., and/or in accordance with a determination that) the third computer system being active with respect to the second portion of the subset of content, the message was received from the second computer system and not the third computer system.

In some examples, the subset of content is a first subset of content. In some examples, in accordance with (e.g., and/or in accordance with a determination that) the second computer system being active with respect to a third portion of a second subset of content different from the first subset of content and that the second subset of content is not shared with the first user, the first computer system disconnects from the second computer system (e.g., without connecting to the third computer system). In some examples, in accordance with (e.g., and/or in accordance with a determination that) the third computer system being active with respect to the third portion of the second subset of content and that the second subset of content is not shared with the first user, the first computer system disconnects from the second computer system (e.g., without connecting to the third computer system). In some examples, in accordance with (e.g., and/or in accordance with a determination that) the second computer system (and/or third computer system) being active with respect to the third portion of the second subset of content and that the second subset of content is shared with the first user, the first computer system continues to be connected to the second computer system.

In some examples, the subset of content is a first subset of content. In some examples, in accordance with (e.g., and/or in accordance with a determination that) the second computer system being active with respect to the third portion of the second subset of content and that the second subset of content is not shared with the first user, the first computer system forgoes displaying the first indication and the second indication. In some examples, in accordance with (e.g., and/or in accordance with a determination that) the third computer system being active with respect to the third portion of the second subset of content and that the second subset of content is not shared with the first user, the first computer system forgoes displaying the first indication and the second indication. In some examples, in accordance with the second computer system (and/or third computer system) being active with respect to the third portion of the second subset of content and that the second subset of content is shared with the first user, the first computer system does not display the first indication and the second indication and, in some examples, displays an indication that the presence of the second user is detected in relation to the third portion of the second subset of content.

Note that details of the processes described above with respect to method 1100 (e.g., FIG. 11) are also applicable in an analogous manner to other methods described herein. For example, method 1100 optionally includes one or more of the characteristics of the various methods described above with reference to methods 1000. For example, the method 1000 can be used to manage a connection between a computer system of method 1100 and other computer systems so that the computer system of method 1100 can update one or more indications. For brevity, these details are not repeated below.

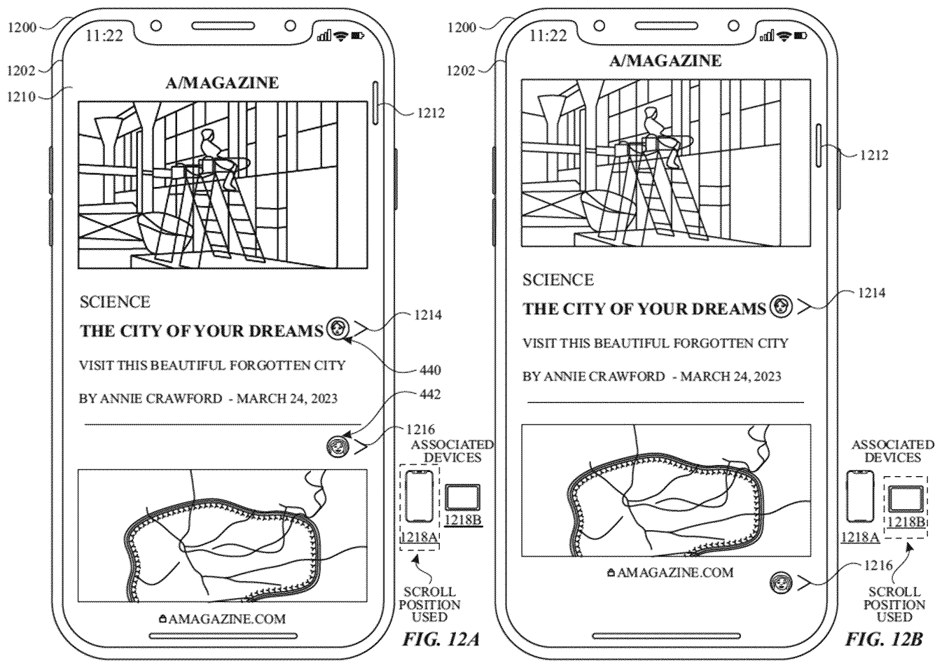

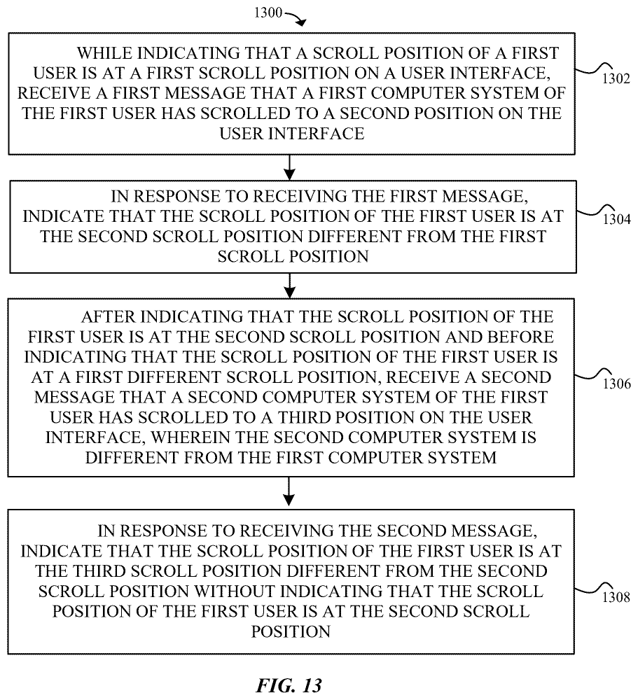

FIGS. 12A and 12B illustrate exemplary user interfaces for updating shared tab group data in accordance with some examples. The user interfaces in FIGS. 12A and 12B are used to illustrate the processes described below, including the processes in FIG. 13.

FIG. 12A illustrates computer system 1200 that includes a display component, which is touch-sensitive display 1202 (herein after “display 1202”). Computer system 1200 includes one or more features of compute system 100 of FIG. 1, device 200 of FIG. 2, and/or computer system 400 of FIG. 4.

As illustrated in FIG. 12A, computer system 1200 displays, via display 1202, web page interface 1210, which includes content from a web page represented by a tab that is part of a shared tab group (e.g., the web page represented by tab 432 of FIG. 4B). Web page interface 1210 includes scroll indicator 1212, representing a scroll position of the web page as it is displayed on display 1202. In the example illustrated in FIG. 12A, the entire length of the right side of the display 1202 (from the top nearest the title of the web page to the bottom nearest the URL of the web page) is a scaled representation of the full length of the web page. In FIG. 12A, scroll indicator 1212 is near the top, indicating that computer system 1200 is displaying the web page near the top of the web page.

In the scenario illustrated by FIG. 12A, computer system 1200 receives a message that includes position information for one or more other members of a shared tab group. In some examples, position information includes an indication of a position of a cursor (e.g., displayed on an interface of a computer system other than computer system 1200 and controlled by a corresponding user). In some examples, position information includes an indication of a scroll position (e.g., of the content as it is displayed in a web page interface on a computer system other than computer system 1200).

As illustrated in FIG. 12A, web page interface 1210 includes scroll indicator 1214 representing a scroll position of another user that is a member of the shared tab group. In this scenario, scroll indicator 1214 represents the scroll position of the first user associated with first user indicator 440 described above with respect to FIG. 4B. In some examples, scroll indicator 1214 includes first user indicator 440 (e.g., an avatar, a picture, initials, color, and/or a representation associated with the corresponding user). In some examples, the scroll indicator 1214 does not include first user indicator 440 (e.g., is an arrow without an avatar). As illustrated in FIG. 12A, web page interface 1210 includes scroll indicator 1216 representing a scroll position of another user that is a member of the shared tab group. In this scenario, scroll indicator 1216 represents the scroll position of the second user associated with first user indicator 442 described above with respect to FIG. 4B. For example, in the scenario of FIG. 12B, the second user associated with first user indicator 442 (of FIG. 4B) is currently present in tab 432 (whereas in FIG. 4B they are illustrated as present in tab 434).

In some examples, a user (e.g., a member of a shared tab group) is associated with multiple computer systems. FIG. 12A includes a schematic that includes indications of multiple computer systems associated with scroll indicator 1216 (e.g., associated with a user represented by scroll indicator 1216). As illustrated in FIG. 12A, the second user of FIG. 4B (associated with scroll indicator 1216) is associated with two computer systems, computer system 1218A (e.g., a smartphone) and computer system 1218B (e.g., a tablet computer). In some examples, a scroll position of a user in a shared tab group is based on one computer system of the multiple computer systems associated with the user. For example, in FIG. 12A, the scroll position of scroll indicator 1216 is based on computer system 1218A. In some examples, each computer system of the multiple computer systems is at a different respective scroll position. For example, the second user of FIG. 4B can have tab 432 open on both their smartphone and their tablet, and the web page can be concurrently scrolled to different positions on each. In some examples, the scroll position of one computer system is used (e.g., by computer system 1200) as the representative scroll position (e.g., for display as scroll indicator 1216). In some examples, which computer system of multiple computer systems to use for the representative scroll position is determined based on presence information originating from that computer system (e.g., transmitted by that computer system, and/or generated based on use of that computer system). In some examples, which computer system of multiple computer systems to use for the representative scroll position is determined based on recency of presence (e.g., the most recent computer system to have scrolled or otherwise been interacted is reported as the representative scroll position for the corresponding user).

FIG. 12B illustrates computer system 1200 displaying, via display 1202, web page interface 1210, which includes a depiction of content from same web page of FIG. 12A but scrolled farther down toward the bottom of the content. Subsequent to scrolling web page interface 1210 (e.g., in response to detecting a swipe input via touch-sensitive display 1202), scroll indicator 1212 has moved farther down toward the bottom of the scale (representing the length of the web page content), indicating that the web page content as scrolled down.

As illustrated in FIG. 12B, web page interface 1210 includes scroll indicator 1214 and scroll indicator 1216, as described above with respect to FIG. 12A. Scroll indicator 1214 has not moved (e.g., the corresponding user has not scrolled the web page but is still present) and scroll indicator 1216 has moved further down. In the scenario of FIG. 12B, computer system 1200 receives one or more message that includes position information indicating that the user associated with scroll indicator 1216 has scrolled the web page. FIG. 12A includes a schematic that includes indications of computer system 1218A and computer system 1218B associated with scroll indicator 1216 (e.g., associated with a user represented by scroll indicator 1216). In the scenario of FIG. 12B, the schematic indicates that computer system 1218B is used to determine the representative scroll position for the corresponding user. For example, the user associated with scroll indicator 1216 was using their smartphone (computer system 1218A) to view the web page at the time of FIG. 12A, and later switched to using their tablet computer (computer system 1218B) at the time of FIG. 12B and used it to scroll the position of the web page, so in FIG. 12B the representative position (e.g., position of scroll indicator 1216) is based on computer system 1218B even though the scroll position on computer system 1218A has not changed.

Using presence data, such as based on recency, the position displayed (e.g., by computer system 1200) for a user (e.g., represented as a scroll indicator) represents a position within content that the corresponding user is currently interacting with. In some examples, multiple messages are received that include multiple scroll positions for a user. For example, a scroll position can be reported by each computer system of a user. In some examples, a representative scroll position is selected from the multiple scroll positions (e.g., and other scroll position(s) are ignored and/or discarded). For example, the most recent message received can be used. For example, a scroll position change can trigger sending presence messages, so the most recent presence data represents the most recently used by the user.

In some examples, computer system 1200 detects that a user has left the shared tab group and, in response, ceases to indicate the scroll position of that user. For example, if the user associated with scroll indicator 1216 leaves the shared tab group, computer system 1200 ceases to display scroll indicator 1216 at web page interface 1210.

In some examples, computer system 1200 detects that a user has switched tabs within the shared tab group and, in response, ceases to indicate the scroll position of that user. For example, if the user associated with scroll indicator 1216 changes tabs (e.g., within the shared tab group, or to a tab not in the shared tab group) (e.g., and is present in tab 434 as illustrated in FIG. 4B, and no longer present in tab 432), then computer system 1200 ceases to display scroll indicator 1216 at web page interface 1210. This can occur even if only one of the user's computer systems has switched tabs (e.g., scroll indicator 1216 ceases being displayed at web page interface 1210 irrespective of whether another computer system of that user has not switched tabs). In some examples, based on presence the user associated with indicator 1216 can only be “present” within one tab at a time.

FIG. 13 is a flow diagram illustrating a method (e.g., method 1300) for updating shared tab group data in accordance with some examples. Some operations in method 1300 are, optionally, combined, the orders of some operations are, optionally, changed, and some operations are, optionally, omitted.

As described below, method 1300 provides an intuitive way for updating shared tab group data using a computer system. Method 1300 reduces the cognitive burden on a user for updating shared tab group data using a computer system, thereby creating a more efficient human-machine interface. For battery-operated computing computer systems, enabling a user to update shared tab group data using a computer system faster and more efficiently conserves power and increases the time between battery charges.

At 1302, while indicating (e.g., via displaying an indication and/or a representation of the scroll position, via a variable (e.g., a variable that is not displayed), via a database entry, and/or the like) that a scroll position (e.g., position of a page (e.g., first, middle, last sections of the page, position of a cursor, position of a scroll bar)) of a first user (e.g., a first account and/or at a second computer system of the first user) is at a first scroll position on a user interface (e.g., content, a webpage, a document page, a windowpane, a portion of a user interface, a spreadsheet, and/or a slide), the computer system receives a first message that a first computer system (e.g., as described above in relation to method 900) of the first user has scrolled to a second position on the user interface.

At 1304, in response to receiving the first message (e.g., a message as described above in relation to method 1000 and 1100), the computer system indicates that the scroll position of the first user is at the second scroll position (e.g., instead of and/or without indicating that the scroll position of the first user is at the first scroll position) different from the first scroll position. In some examples, indicating that the scroll position of the first user is at the second scroll position different from the first scroll position includes updating a displayed indication, displaying a new indication, and/or updating one or more variables corresponding to the indication.

At 1306, after indicating that the scroll position of the first user is at the second scroll position and before indicating that the scroll position of the first user is at a first different scroll position (and/or, in some examples, while indicating that the scroll position of the first user is at the second scroll position), the computer system receives a second message (e.g., a message as described above in relation to method 1000 and method 1100) that a second computer system of the first user has scrolled to a third position on the user interface (e.g., from the first scroll position, the second scroll position, and/or a scroll position different from the first, second, and/or third scroll positions), wherein the second computer system is different from the first computer system.

At 1308, in response to receiving the second message, the computer system indicates that the scroll position of the first user is at the third scroll position (e.g., instead of and/or without indicating that the scroll position of the first user is at the second scroll position) different from the second scroll position (and, in some examples, the first scroll position) without indicating that the scroll position of the first user is at the second scroll position.

In some examples, after indicating that the scroll position of the first user is at the third scroll position and before indicating that the scroll position of the first user is at a second different scroll position (e.g., different from the first different scroll position), the computer system receives a third message that a computer system of a second user has scrolled to a fourth position different from the third position, continuing to indicate that the scroll position of the first user is at the third scroll position (e.g., without indicating that the scroll position of the first user is at the fourth scroll position and/or while indicating that a scroll position of the second user is at the fourth scroll position and/or has changed), wherein the second user (and/or second user account) is different from the first user (and/or first user account).

In some examples, a set of user interfaces (e.g., as described above in relation to the subset of content) that includes the user interface is being shared between the first user and a user of the computer system (e.g., that is not the first user and/or different from the first user).

In some examples, while indicating the scroll position of the first user, the computer system detects that the set of user interfaces is no longer being shared with the first user. In some examples, in response to detecting that the set of user interfaces is no longer being shared with the first user, the computer system ceases to indicate the scroll position of the first user.

In some examples, while indicating the scroll position of the first user, the computer system detects that the first computer system has switched from displaying the user interface to display a different user interface. In some examples, in response to detecting that the first computer system has switched from displaying the user interface to display a different user interface, the computer system ceases to indicate the scroll position of the first user. In some examples, the different user interface is included in the set of user interfaces; in some examples, the different user interface is not included in the set of user interfaces.

In some examples, ceasing to indicate the scroll position of the first user occurs irrespective of whether a state of the second computer system has changed (e.g., irrespective of whether the second computer system is displaying the different user interface and/or whether the user interface is continuing to operate in the foreground or, in some examples, the background on the second computer system).

In some examples, the second scroll position is on a first side of the first scroll position (e.g., above, below, left, right, and/or any combination thereof). In some examples, the third scroll position is on a second side (e.g., above, below, left, right, and/or any combination thereof) of the first scroll position different from the first side of the first scroll position.

In some examples, the user interface is scrolled in response to receiving the first message and in response to receiving the second message while the first computer system and the second computer system are connected to an activity session (e.g., a unique session associated with a document accessible to multiple users and/or a service (that, in some examples, is not a part of an identity service)) represented by a respective subset of user interfaces that includes the user interface. In some examples, the user interface is not scrolled in response to receiving the first message and in response to receiving the second message while the first computer system and the second computer system are not connected to the activity represented by the respective subset of user interfaces that includes the user interface.

In some examples, the user interface is scrolled in response to receiving the first message and in response to receiving the second message while the first computer system and the second computer system are connected to each other (and, in some examples, while the first computer system and the second computer system are connected to an activity represented by a respective subset of user interfaces that includes the user interface). In some examples, the user interface is not scrolled in response to receiving the first message and in response to receiving the second message while the first computer system and the second computer system are not connected to each other.

In some examples, the user interface is scrolled in response to receiving the first message and in response to receiving the second message while at least one of the first computer system and the second computer system is connected to a computer system of a third user that is different from the first user. In some examples, the user interface is not scrolled, in response to receiving the first message and in response to receiving the second message, without at least one of the first computer system and the second computer system being connected to the computer system of the third user that is different from the first user.

Note that details of the processes described above with respect to method 1300 (e.g., FIG. 13) are also applicable in an analogous manner to the methods described herein. For example, method 1300 optionally includes one or more of the characteristics of the various methods described above with reference to methods 1000. For example, the method 1000 can be used to manage a connection between a computer system of method 1300 and other computer systems so that the computer system of method 1300 can update one or more indications. For brevity, these details are not repeated below.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how computer systems communicate with each other. The present disclosure contemplates that in some instances, this gathered data can include personal information data that uniquely identifies or can be used to contact or locate a specific person, such as computer system identifiers and/or device identifiers that can be associated with the location of a person. Such personal information data can include and/or be used to find demographic data, location-based data, telephone numbers, email addresses, home addresses, or any other identifying information.

The present disclosure recognizes that the use of such personal information data, in the present technology, can be used to the benefit of users. For example, the personal information data can be used to how computer systems communicate with each other. Accordingly, use of such personal information data enables better and/or faster communication between computer system. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be displayed to users by inferring location based on non-personal information data or a bare minimum amount of personal information, such as the content being requested by the computer system associated with a user or other non-personal information.

What is claimed is:

1. A method, comprising:
identifying a browser associated with a user of a computer system;
in response to identifying the browser, causing a first connection to be established between the computer system and one or more other computer systems of the user;
causing a second connection to be established between the computer system and a service, wherein the second connection is different from the first connection;
while the computer system is connected to the one or more other computer systems via the first connection and while the computer system is connected to the service via the second connection, identifying first data concerning the browser; and
in response to identifying the first data concerning the browser:
in accordance with a determination that the first data includes presence data concerning the browser, sending a message corresponding to the first data via the first connection between the computer system and the one or more other computer systems; and
in accordance with a determination that the first data does not include presence data, sending the message corresponding to the first data via the second connection.

2. The method of claim 1, wherein the first connection is a peer-to-peer connection.

3. The method of claim 1, wherein the first connection includes a client-server connection.

4. The method of claim 1, wherein the computer system is connected to the one or more other computer systems via the first connection between the computer system and the one or more other computer systems while being concurrently connected to the service via the second connection between the computer system and the service.

5. The method of claim 1, further comprising:
after detecting the presence of the user with respect to the browser and while the first connection between the computer system and the one or more other computer systems is established, detecting that the presence of the user is no longer detected with respect to the browser; and
in response to detecting that the presence of the user is no longer detected with respect to the browser, causing the first connection between the computer system and the one or more other computer systems to be terminated.

6. The method of claim 5, wherein the presence of the user is not detected while the browser is operating in the background.

7. The method of claim 5, wherein the presence of the user is not detected in response to a browser application including the browser being exited.

8. A non-transitory computer-readable storage medium storing one or more programs configured to be executed by one or more processors of a computer system, the one or more programs including instructions for:
identifying a browser associated with a user of a computer system;
in response to identifying the browser, causing a first connection to be established between the computer system and one or more other computer systems of the user;
causing a second connection to be established between the computer system and a service, wherein the second connection is different from the first connection;
while the computer system is connected to the one or more other computer systems via the first connection and while the computer system is connected to the service via the second connection, identifying first data concerning the browser; and
in response to identifying the first data concerning the browser:
in accordance with a determination that the first data includes presence data concerning the browser, sending a message corresponding to the first data via the first connection between the computer system and the one or more other computer systems; and
in accordance with a determination that the first data does not include presence data, sending the message corresponding to the first data via the second connection.

9. A computer system, comprising:
one or more processors; and
memory storing one or more programs configured to be executed by the one or more processors, the one or more programs including instructions for:
identifying a browser associated with a user of a computer system;
in response to identifying the browser, causing a first connection to be established between the computer system and one or more other computer systems of the user;
causing a second connection to be established between the computer system and a service, wherein the second connection is different from the first connection;
while the computer system is connected to the one or more other computer systems via the first connection and while the computer system is connected to the service via the second connection, identifying first data concerning the browser; and
in response to identifying the first data concerning the browser:
in accordance with a determination that the first data includes presence data concerning the browser, sending a message corresponding to the first data via the first connection between the computer system and the one or more other computer systems; and
in accordance with a determination that the first data does not include presence data, sending the message corresponding to the first data via the second connection.
